(19) United States
(12) Patent Application Publication
(10) Pub. No.: US 2024/0046494 A1
(43) Pub. Date: Feb. 8, 2024

(54) IMAGE PROCESSING DEVICE, IMAGE PROCESSING METHOD, AND IMAGE PROCESSING PROGRAM

(71) Applicant: FUJIFILM Corporation, Tokyo (JP)

(72) Inventor: Kimito KATSUYAMA, Tokyo (JP)

(73) Assignee: FUJIFILM Corporation, Tokyo (JP)

(21) Appl. No.: 18/491,723

(22) Filed: Oct. 20, 2023

Related U.S. Application Data
(63) Continuation of application No. PCT/JP2022/016570, filed on Mar. 31, 2022.

(30) Foreign Application Priority Data
May 13, 2021 (JP) 2021-081486

(51) Int. Cl. G06T 7/50; G06T 7/73

(52) U.S. Cl. CPC G06T 7/50; G06T 7/73; G06T 2207/10012; G06T 2207/30184

(57) ABSTRACT

There are provided an image processing device, an image processing method, and an image processing program that can reduce misregistration in associating a plurality of images. In an image processing device according to an aspect of the present invention, a processor acquires a first image and a second image in which the same object is imaged from different positions and which are two-dimensional images captured in different wavelength ranges, acquires information indicating positions of reference points on a surface of the object, and associates values of the first image with values of the second image on the basis of the acquired first image, the acquired second image, and the acquired information. The values of the first image and the values of the second image correspond to non-reference points that are points other than the reference points on the surface.

### CROSS-REFERENCE TO RELATED APPLICATIONS

The present application is a Continuation of PCT International Application No. PCT/JP2022/016570 filed on Mar. 31, 2022 claiming priority under 35 U.S.C § 119(a) to Japanese Patent Application No. 2021-081486 filed on May 13, 2021. Each of the above applications is hereby expressly incorporated by reference, in its entirety, into the present application.

### BACKGROUND OF THE INVENTION

### 1. Field of the Invention

The present invention relates to an image processing device, an image processing method, and an image processing program, and more particularly, to a technique for registering a plurality of images.

### 2. Description of the Related Art

Since a structure, such as a tunnel or a bridge, deteriorates due to aging or the like, there is a demand for a diagnostic method capable of accurately diagnosing the soundness of the structure. A method including acquiring an image of a structure and diagnosing the structure on the basis of the image has been proposed as such a diagnostic method. For example, there have been proposed a method including acquiring a visible image of a structure and making a diagnosis and a method including acquiring an infrared image and making a diagnosis. In a case where a visible image is used, it is possible to detect a surface defect, such as fissuring or peeling, in a structure, such as concrete, mortar, and tile. In a case where an infrared image is used, it is possible to detect internal defects, such as floating. A method of acquiring both a visible image and an infrared image to make a diagnosis has also been proposed. For example, JP2012-098170A discloses a method including acquiring visible image data and infrared image data related to a structure using a normal camera and an infrared camera, superimposing these image data to form a hybrid image, and diagnosing the structure using this hybrid image.

### SUMMARY OF THE INVENTION

In a case where a diagnosis is made on the basis of both a visible image and an infrared image, the visible image and the infrared image are often superimposed as in JP2012-098170A. However, in a case where the visible image and the infrared image are superimposed, the positions of each point on an object shown in the visible image and the infrared image do not coincide with each other. Specifically, since the normal camera and the infrared camera do not have the same angle of view, the same imaging position, and the like, the positions of each point on the object in the respective images captured by the respective cameras do not coincide with each other. With regard to this problem, JP2012-098170A discloses that the visible image and the infrared image are subjected to deformation correction and are subjected to scale correction as necessary so that the positions of reference points on the object imaged in the visible image and the infrared image coincide with each other. However, even though the images are subjected to geometric correction so that the positions of the reference points coincide with each other, the positions of points other than the reference points in the visible image and the infrared image do not necessarily coincide with each other. That is, misregistration between the visible image and the infrared image is not necessarily eliminated.

There is a possibility that misregistration remains as described above in the related art in a case where a plurality of images are associated with each other. In a structure, there are often cases where a surface defect, such as fissuring or peeling, is also present at the same portion as a portion where an internal defect, such as floating, is present or at a portion adjacent to the portion. Accordingly, the surface defect, such as fissuring or peeling, is also diagnosed on the basis of the visible image at the same time in a case where an internal defect, such as floating, is diagnosed on the basis of the infrared image. As a result, it is possible to discriminate floating, which is accompanied by such fissuring or peeling, from floating that is not accompanied by such fissuring or peeling. Further, there is a problem in that many false detections occur in the diagnosis of an internal defect, such as floating, based on the infrared image, but most portions where false detections may occur can be discriminated from the state of the surface of the structure on the basis of the visible image. Accordingly, since the visible image is also used at the same time in the diagnosis of an internal defect, such as floating, based on the infrared image, the performance of the diagnosis of the internal defect, such as floating, can be improved (the discrimination of floating accompanied by fissuring or peeling and floating not accompanied by fissuring or peeling, and the reduction (discrimination) of false detection). However, in a case where there is misregistration between the visible image and the infrared image, there is a concern that inconvenience may occur in achieving the improvement of performance using the visible image described above.

The present invention has been made in view of such circumstances, and an object of the present invention is to provide an image processing device, an image processing method, and an image processing program that can reduce misregistration in associating a plurality of images.

An image processing device according to a first aspect of the present invention is an image processing device comprising a processor, in which the processor acquires a first image and a second image in which the same object is imaged from different positions and which are two-dimensional images captured in different wavelength ranges, acquires information indicating positions of reference points on a surface of the object, and associates values of the first image with values of the second image on the basis of the acquired first image, the acquired second image, and the acquired information, the values of the first image and the values of the second image corresponding to non-reference points that are points other than the reference points on the surface.

In the first aspect and each of the following aspects, a case where the first image and the second image are “captured in different wavelength ranges” includes not only a case where wavelength ranges do not overlap with each other at all but also a case where wavelength ranges partially overlap with each other and are partially different from each other. Further, a case where wavelength ranges are equal to each other also includes a case where spectral sensitivity characteristics are different from each other and peak sensitivity wavelengths are different from each other (also includes a case where it is regarded that wavelength ranges are regarded as substantially “different wavelength ranges”).

According to a second aspect, in the image processing device according to the first aspect, the information is information that is acquired on the basis of the first image and the second image.

According to a third aspect, in the image processing device according to the first or second aspect, at least one of the reference points is a point present at any one of an end, a curved portion, or a boundary of the object.

According to a fourth aspect, in the image processing device according to any one of the first to third aspects, the information is information that is acquired on the basis of a distance measured by a distance measuring unit.

According to a fifth aspect, in the image processing device according to any one of the first to fourth aspects, the processor estimates positions of the non-reference points on the basis of the information (information indicating the positions of the reference points).

According to a sixth aspect, in the image processing device according to any one of the first to fifth aspects, the processor estimates a shape of the surface on the basis of the information, and estimates positions of the non-reference points on the basis of the estimated shape.

According to a seventh aspect, in the image processing device according to the sixth aspect, the processor estimates the shape as a set of flat surfaces, each of which being defined by three reference points.

According to an eighth aspect, in the image processing device according to the sixth or seventh aspect, the processor estimates the shape on an assumption that the surface is a surface having a predetermined shape.

According to a ninth aspect, in the image processing device according to the eighth aspect, the processor estimates the shape on an assumption that the surface is a flat surface.

According to a tenth aspect, in the image processing device according to the eighth aspect, the processor estimates the shape on an assumption that the surface is a cylindrical surface.

According to an eleventh aspect, in the image processing device according to any one of the first to tenth aspects, the processor discriminates the surface of the object on the basis of the values of at least one image of the first image or the second image.

According to a twelfth aspect, in the image processing device according to any one of the first to eleventh aspects, the processor generates data in which the values of the first image and the values of the second image corresponding to at least the non-reference points are superimposed at the same pixel positions, and/or superimposes the values of the first image and the values of the second image, which correspond to at least the non-reference points, at the same pixel positions and causes a display device to display the superimposed values.

According to a thirteenth aspect, in the image processing device according to any one of the first to twelfth aspects, the processor acquires an image which is captured with light having a wavelength range including at least a part of a wavelength range of visible light as one image of the first image and the second image, and acquires an image which is captured with light having a wavelength range including at least a part of a wavelength range of infrared light as the other image of the first image and the second image.

According to a fourteenth aspect, in the image processing device according to any one of the first to thirteenth aspects, the processor acquires the first image and the second image in which a concrete structure as the object is imaged.

An image processing method according to a fifteenth aspect of the present invention is an image processing method that is executed by a processor, and includes: acquiring a first image and a second image in which the same object is imaged from different positions and which are two-dimensional images captured in different wavelength ranges, acquiring information indicating positions of reference points on a surface of the object, and associating values of the first image with values of the second image on the basis of the acquired first image, the acquired second image, and the acquired information, the values of the first image and the values of the second image corresponding to non-reference points that are points other than the reference points on the surface.

According to the fifteenth aspect, as in the first aspect, it is possible to reduce misregistration in associating a plurality of images. In the image processing method according to the fifteenth aspect, the same processing as that in the second to fourteenth aspects may be further executed.

An image processing program according to a sixteenth aspect of the present invention is an image processing program that is executed by a processor, and includes: acquiring a first image and a second image in which the same object is imaged from different positions and which are two-dimensional images captured in different wavelength ranges, acquiring information indicating positions of reference points on a surface of the object, and associating values of the first image with values of the second image on the basis of the acquired first image, the acquired second image, and the acquired information, the values of the first image and the values of the second image corresponding to non-reference points that are points other than the reference points on the surface.

According to the sixteenth aspect, as in the first and fifteenth aspects, it is possible to reduce misregistration in associating a plurality of images. The image processing program according to the sixteenth aspect may be a program that causes the same processing as that in the second to fourteenth aspects to be further executed. A non-transitory recording medium in which a computer readable code of the program of the aspects is recorded can also be mentioned as an aspect of the present invention.

As described above, according to the image processing device, the image processing method, and the image processing program of the aspects of the present invention, it is possible to reduce misregistration in associating a plurality of images.

### BRIEF DESCRIPTION OF THE DRAWINGS

FIG. 1 is a diagram schematically showing imaging systems and a surface of an object to be imaged.

FIGS. 2A and 2B are diagrams showing an example in which reference points and non-reference points coincide with each other via geometric correction.

FIGS. 3A and 3B are diagrams showing an example in which non-reference points do not coincide with each other due to geometric correction.

FIGS. 4A and 4B are other diagrams showing an example in which non-reference points do not coincide with each other due to geometric correction.

FIG. 5 is another diagram schematically showing the imaging systems and the surface of the object to be imaged.

FIGS. 6A and 6B are still other diagrams showing an example in which non-reference points do not coincide with each other due to geometric correction.

FIGS. 7A and 7B are yet other diagrams showing an example in which non-reference points do not coincide with each other due to geometric correction.

FIGS. 8A and 8B are even other diagrams showing an example in which non-reference points do not coincide with each other due to geometric correction.

FIG. 9 is a diagram showing a configuration of an image processing system according to an embodiment.

FIG. 10 is a diagram showing a bridge that is an example of a concrete structure.

FIG. 11 is a diagram showing a functional configuration of a processing unit.

FIG. 12 is a flowchart showing a procedure of an image processing method.

FIG. 13 is a diagram showing an aspect in which reference points are set on a surface of an object.

FIGS. 14A and 14B are enlarged views of a visible image and an infrared image shown in FIG. 13.

FIGS. 15A and 15B are diagrams showing examples in which reference points are specified in a visible image and an infrared image.

FIGS. 16A and 16B are diagrams showing aspects in which boundaries of a surface of an object are extracted as reference points.

FIGS. 17A, 17B, 17C, and 17D are diagrams showing examples of results in which connected regions are discriminated on the basis of spatial features.

FIG. 18 is a schematic diagram showing an aspect of an arrangement of non-reference points based on a parallel projection model.

FIGS. 19A and 19B are diagrams showing examples of results of estimating values of a visible image and an infrared image.

FIG. 20 is a diagram showing an example of a result in which a value of a visible image and a value of an infrared image are superimposed on the same image position.

FIG. 21 is a diagram showing an example in which superimposed data are shown in the form of a table.

FIGS. 22A, 22B, and 22C are diagrams showing examples of a visible image, an infrared image, and a superimposed image.

### DESCRIPTION OF THE PREFERRED EMBODIMENTS

An image processing device, an image processing method, and an image processing program according to embodiments of the present invention will be described in detail below with reference to the accompanying drawings.

First, a problem of misregistration in associating a plurality of images, and particularly, a problem caused by such misregistration in a case where a visible image is also used at the same time in a diagnosis of an internal defect, such as floating, based on an infrared image will be described in detail. In a case where a diagnosis is made on the basis of both a visible image and an infrared image, the visible image and the infrared image are often superimposed. However, in a case where the visible image and the infrared image are superimposed, the positions of the respective points on an object shown in the visible image and those shown in the infrared image do not coincide with each other. Specifically, since a normal camera and an infrared camera do not have the same angle of view, the same imaging position, and the like, the positions of each point on the object in the respective images captured by the respective cameras do not coincide with each other. With regard to this problem, even though deformation correction and scale correction are performed on the visible image and the infrared image so that the positions of reference points on the object captured in the visible image and the infrared image coincide with each other, that is, even though the images are subjected to geometric correction so that the positions of the reference points coincide with each other, the positions of points other than the reference points in the visible image and the infrared image do not necessarily coincide with each other. That is, misregistration between the visible image and the infrared image is not necessarily eliminated.

As described above, there is a possibility that misregistration remains in a case where a plurality of images are associated with each other. “A plurality of images are associated” means that corresponding values of a plurality of images are associated with the respective points on the object. Further, “misregistration between a plurality of images” means that positions in a plurality of images corresponding to the respective points on the object do not coincide with each other as described above. This means that corresponding values of a plurality of images are mistakenly associated with the respective points on the object. That is, misregistration between a first image and a second image means that a position in the first image and a position in the second image corresponding to the same point on a surface of the object do not coincide with each other, and means that a position in the first image and a position in the second image corresponding to different points on the surface of the object mistakenly coincide with each other. That is, misregistration between the first image and the second image means that “a value of the first image and a value of the second image corresponding to different points on the surface of the object” is mistakenly regarded as “a value of the first image and a value of the second image corresponding to the same point” and associated with the same point. Even if a plurality of images are subjected to geometric correction so that values of the plurality of images corresponding to reference points on the object are correctly associated, values of the plurality of images corresponding to points other than the reference points on the object cannot necessarily be associated correctly. In a structure, there are often cases where a surface defect, such as fissuring or peeling, is also present at the same portion as a portion where an internal defect, such as floating, is present or at a portion adjacent to the portion. Accordingly, the surface defect, such as fissuring or peeling, is also diagnosed on the basis of the visible image at the same time in a case where an internal defect, such as floating, is diagnosed on the basis of the infrared image. As a result, it is possible to discriminate floating, which is accompanied by such fissuring or peeling, from floating that is not accompanied by such fissuring or peeling. Further, there is a problem in that many false detections occur in the diagnosis of an internal defect, such as floating, based on the infrared image, but it is effective to use the visible image to solve the problem. Specifically, in a case where a structure is repaired even though an internal defect, such as floating, is not present in the structure, in a case where a foreign substance, such as free lime, adheres to the surface of the structure, in a case where there are color unevenness (mold, moss, a release agent, a water effect, or the like), masonry joints, steps, slag, sand streaks, rust fluid, rust, water leakage, and surface unevenness on the surface of the structure, and the like, there are portions where a false detection may be made since a surface temperature (actual and/or apparent surface temperature) is different from the surroundings in the infrared image. However, most of such portions can be discriminated from a surface state of the structure on the basis of the visible image. Accordingly, since the visible image is also used at the same time in the diagnosis of an internal defect, such as floating, based on the infrared image, the performance of the diagnosis of the internal defect, such as floating, can be improved (the discrimination of floating accompanied by fissuring or peeling and floating not accompanied by fissuring or peeling, and the reduction (discrimination) of false detection). However, in a case where there is misregistration between the visible image and the infrared image, it is difficult to improve performance using the visible image as described above.

[Details of Problem]

Next, a problem in that the positions of points other than the reference points do not coincide with each other even though the images are subjected to geometric correction so that the positions of the reference points on the surface of the object coincide with each other will be described in detail. In the following description, any one of an imaging system for a visible image (an image captured with light having a wavelength range including at least a part of a wavelength range of visible light (a wavelength of about 400 nm to 800 nm), the same shall apply hereinafter) or an imaging system for an infrared image (an image captured with light having a wavelength range including at least a part of a wavelength range of infrared light (about 700 nm to 1 mm)) will be referred to as an imaging system 1, and the other thereof will be referred to as an imaging system 2.

[Case where Surface of the Object is Straight (Flat Surface)]

[Case where Positions of Non-Reference Points Coincide with Each Other]

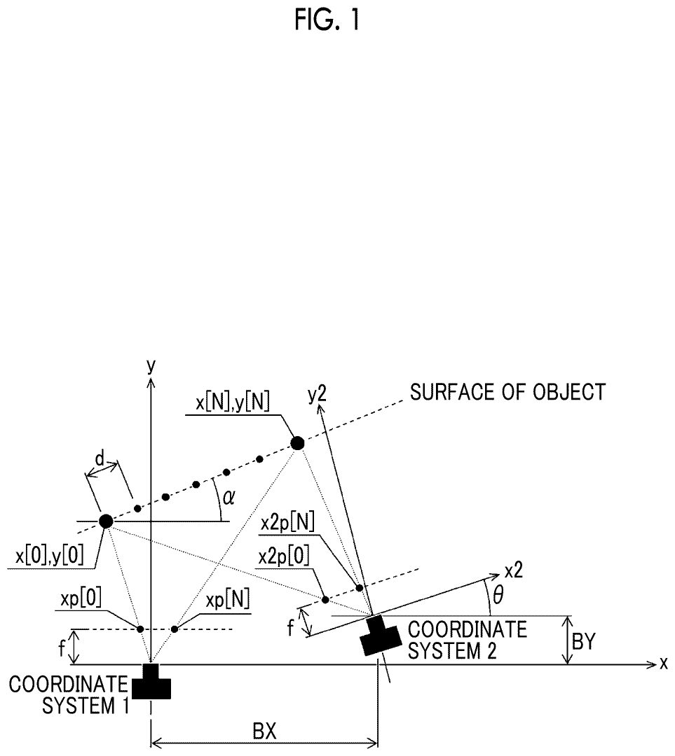

FIG. 1 is a diagram schematically showing the imaging system 1, the imaging system 2, and a surface of an object to be imaged in an xy coordinate space. Although an actual space of the object to be imaged is three-dimensional, the actual space is assumed to be two-dimensional in FIG. 1 for the purpose of description. In FIG. 1, an optical center of the imaging system 1 is an origin of an xy coordinate system, an optical axis thereof coincides with a y axis, and a coordinate system of the imaging system 1 is represented by coordinates (x, y) (hereinafter, the coordinate system of the imaging system 1 will also be referred to as a coordinate system 1). Further, a coordinate system of the imaging system 2 is a coordinate system that is the coordinate system 1 translated in an x direction by BX, translated in a y direction by BY, and rotated by an angle θ, and is represented by coordinates (x2, y2) (hereinafter, the coordinate system of the imaging system 2 will also be referred to as a coordinate system 2). An optical center of the imaging system 2 coincides with an origin of the coordinate system 2, and an optical axis thereof coincides with ay2 axis. Here, f denotes focal lengths of the imaging systems 1 and 2, and an imaging surface of each imaging system is virtually shown at a position that is in front of each optical center and away from each optical center by the focal length f. An image in which the intensity of light reflected and emitted from the respective points on the surface of the object in the space of the object to be imaged as viewed from the optical center is projected onto the imaging surface is a captured image.

As shown in FIG. 1, the surface of the object is assumed to be straight, points P[0], P[1] . . . , P[N] arranged on the surface at regular intervals d are considered, and a positional relationship between the respective points on the imaging surface of the imaging system 1 (hereinafter, the imaging surface of the imaging system 1 will also be referred to as an imaging surface 1) and on the imaging surface of the imaging system 2 (hereinafter, the imaging surface of the imaging system 2 will also be referred to as an imaging surface 2) is considered. Here, the focal length f is assumed to be 1. First, the coordinates (x, y) in the coordinate system 1 are projected onto coordinates xp on the imaging surface 1 as shown in the following Equation (1).

xp=x/y (1)

Further, the coordinates (x, y) in the coordinate system 1 can be transformed into the coordinates (x2, y2) in the coordinate system 2 by the following Equations (2a) to (2d), and can be projected onto coordinates x2p on the imaging surface 2 by the following Equation (2e). Equations (2a) and (2b) represent the translation of the coordinate system, Equations (2c) and (2d) represent the rotation thereof, and θ is defined to be positive in a counterclockwise direction.

xs=x−BX (2a)

ys=y−BY (2b)

x2=xs*cos(θ)+ys*sin(θ) (2c)

y2=−xs*sin(θ)+ys*cos(θ) (2d)

x2p=x2/y2 (2e)

Next, in a case where coordinates of the points P[0], P[1] . . . , P[N] in the coordinate system 1 are denoted by (x[0], y[0]), . . . , (x[N], y[N]), respectively, these coordinates are represented by the following Equations (3a) and (3b). Here, i is 0, 1, . . . , N. Further, a denotes an angle from an x axis on a positive side and is defined to be positive in the counterclockwise direction.

x[i]=x[0]+i*d*cos(α) (3a)

y[i]=y[0]+i*d*sin(α) (3b)

In a case where x[i] and y[i] of Equations (3a) and (3b) are put into Equation (1), coordinates xp[0], xp[1], . . . , xp[N] on the imaging surface 1 can be obtained for the points P[0], P[1] . . . , P[N], respectively. Further, in a case where x[i] and y[i] of Equations (3a) and (3b) are put into Equations (2a) to (2d) and Equation (2e), coordinates x2p[0], x2p[1], . . . , x2p[N] on the imaging surface 2 can be obtained for the points P[0], P[1] . . . , P[N], respectively.

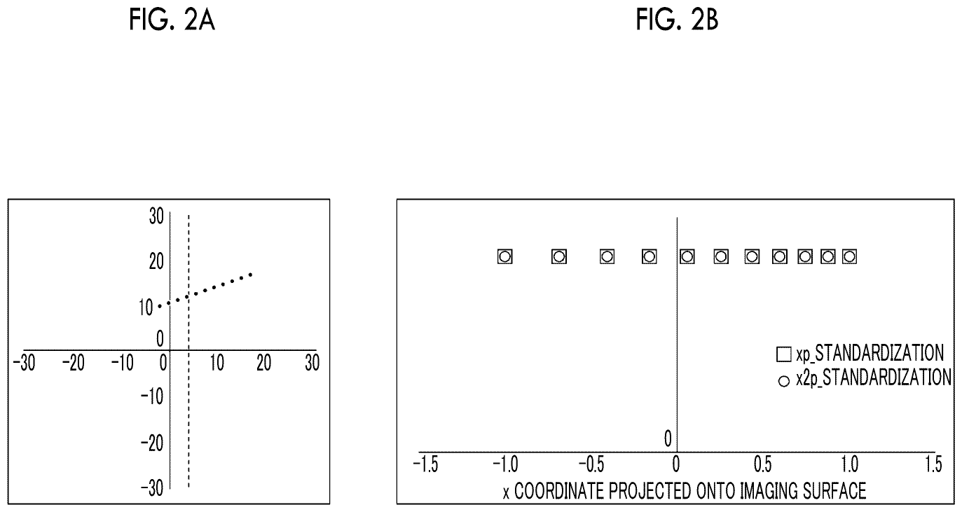

Coordinates xp[0], . . . , xp[N] of the points P[0], . . . , P[N] on the imaging surface 1 and coordinates x2p[0], . . . , x2p[N] of the points P[0], . . . , P[N] on the imaging surface 2 are obtained from the above-mentioned equations and compared with each other, and results thereof are shown for some examples. First, results in a case where x[0] is −2 m, y[0] is 10 m, d is 2 m, α is 20°, N is 10, BX is 4 m, BY is 0 m, and θ is 0° are shown in FIGS. 2A and 2B. FIG. 2A shows the coordinate system 1, the coordinate system 2, and the arrangement of points P[0], . . . , P[10]. In FIG. 2B, coordinates xp[0], . . . , xp[10] on the imaging surface 1 are indicated by □ (square symbol), and coordinates x2p[0], . . . , x2p[10] on the imaging surface 2 are indicated by ∘ (circular symbol). Here, it is assumed that the points P[0] and P[10] are used as reference points and the respective captured images are subjected to geometric correction so that the coordinates xp[0] and xp[10] on the imaging surface 2 and the coordinates x2p[0] and x2p[10] on the imaging surface 2 coincide with each other, and the coordinates of the respective points are corrected so that the coordinates xp[0] and x2p[0] are, for example, −1 and the coordinates xp[10] and x2p[10] are, for example, 1. Hereinafter, this correction will be referred to as standardization. Further, the captured image corresponding to the imaging surface 1 is referred to as a captured image 1, and the captured image corresponding to the imaging surface 2 is referred to as a captured image 2. It can be seen from FIGS. 2A and 2B that the standardized coordinates xp[0], . . . , xp[10] and the standardized coordinates x2p[0], . . . , x2p[10] coincide with each other. That is, it can be seen that the positions of points other than the reference points also coincide with each other in a case where the points P[0] and P[10] are used as reference points and the captured images 1 and 2 are subjected to geometric correction so that the positions of the reference points coincide with each other. Hereinafter, the points other than the reference points will be referred to as non-reference points.

[Case where Positions of Non-Reference Points do not Coincide with Each Other (Part 1)]

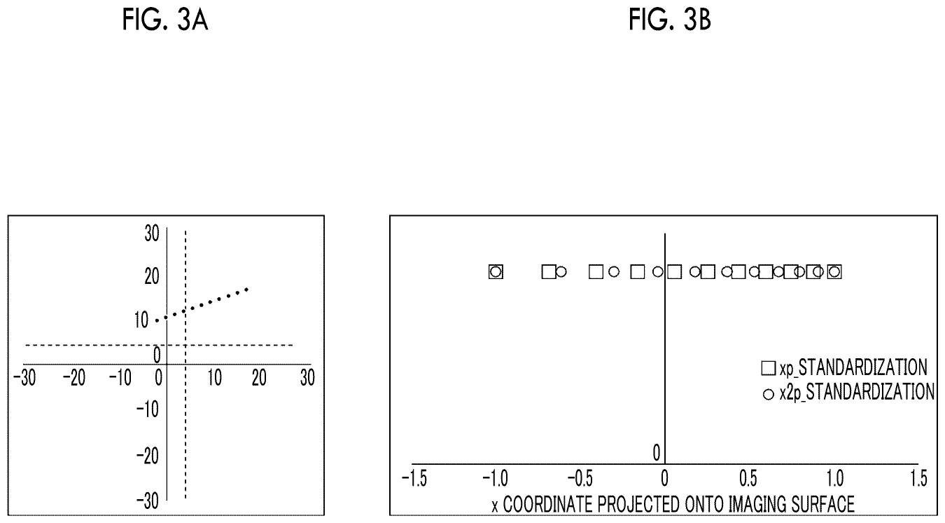

Next, results in a case where the coordinate system 1 and the arrangement of the points P[0], . . . , P[10] are set to be the same as those in FIGS. 2A and 2B and only the coordinate system 2 is changed, specifically, BX is set to 4 m, BY is set to 4 m, and θ is set to 0°, are shown in FIGS. 3A and 3B. Viewpoints in FIGS. 3A and 3B are same as those in FIGS. 2A and 2B. It can be seen from FIGS. 3A and 3B that the standardized coordinates xp[1], . . . , xp[9] and the standardized coordinates x2p[1], . . . , x2p[9] do not coincide with each other. That is, it can be seen that the positions of non-reference points do not coincide with each other even though the points P[0] and P[10] are used as reference points and the captured images 1 and 2 are subjected to geometric correction so that the positions of the reference points coincide with each other.

[Case where Positions of Non-Reference Points do not Coincide with Each Other (Part 2)]

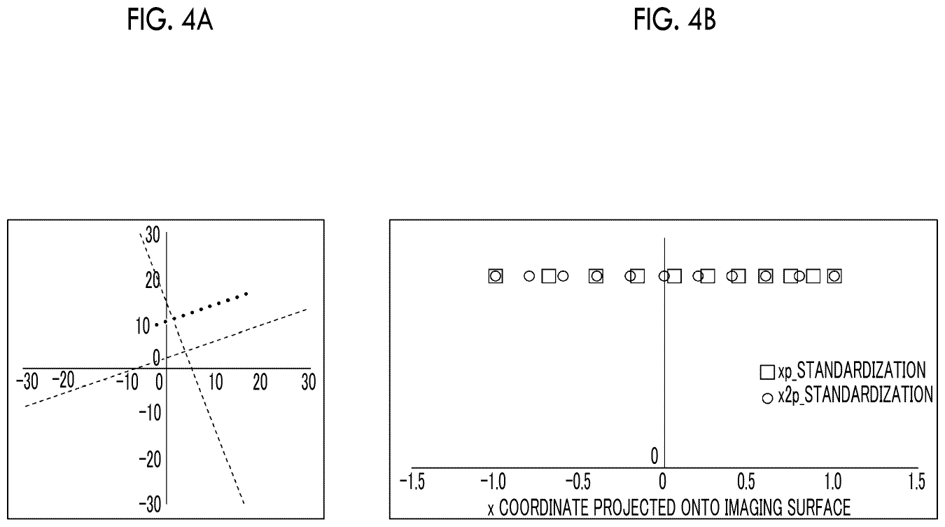

Next, results in a case where the coordinate system 1 and the arrangement of the points P[0], . . . , P[10] are set to be the same as those in FIGS. 2A and 2B and only the coordinate system 2 is changed, specifically, BX is set to 4 m, BY is set to 4 m, and θ is set to 20°, are shown in FIGS. 4A and 4B. Viewpoints in FIGS. 4A and 4B are the same as those in FIGS. 2A and 2B. It can be seen from FIGS. 4A and 4B that, as in FIGS. 3A and 3B, the standardized coordinates xp[1], . . . , xp[9] and the standardized coordinates x2p[1], . . . , x2p[9] do not coincide with each other, that is, the positions of non-reference points do not coincide with each other, even though the points P[0] and P[10] are used as the positions of reference points and the captured images 1 and 2 are subjected to geometric correction so that the positions of the reference points coincide with each other.

Likewise, even in a case where the coordinate system 1 and the arrangement of the points P[0], . . . , P[10] are set to be the same as those in FIGS. 2A and 2B and only the coordinate system 2 is changed, specifically, BX is set to 4 m, BY is set to 0 m, and θ is set to 20°, a case where the coordinate system 1 and the arrangement of the points P[0], . . . , P[10] are set to be the same as those in FIGS. 2A and 2B and BX is set to 0 m, BY is set to 4 m, and θ is set to 0°, and a case where the coordinate system 1 and the arrangement of the points P[0], . . . , P[10] are set to be the same as those in FIGS. 2A and 2B and BX is set to 0 m, BY is set to 4 m, and θ is set to 20°, results in which the coordinates xp[1], . . . , xp[9] and the coordinates x2p[1], . . . , x2p[9] do not coincide with each other, that is, the positions of non-reference points do not coincide with each other, are obtained (drawings will be omitted).

It can be seen from the above description that, in a case where the surface of the object is straight, the positions of non-reference points do not coincide with each other even though the captured images 1 and 2 are subjected to geometric correction so that the positions of the reference points on the surface of the object coincide with each other, except for a case where the optical axes of the imaging systems 1 and 2 are parallel to each other and there is no misregistration in the direction of the optical axis (the imaging systems 1 and 2 are lined up in a direction perpendicular to the optical axis).

Here, since it is difficult to make the optical axes of the imaging systems 1 and 2 completely parallel to each other and to completely eliminate misregistration, it is considered that the positions of non-reference points do not coincide with each other in any case.

[Case where Surface of Object is Curved (Curved Surface)]

[Case where Positions of Non-Reference Points do not Coincide with Each Other (Part 1)]

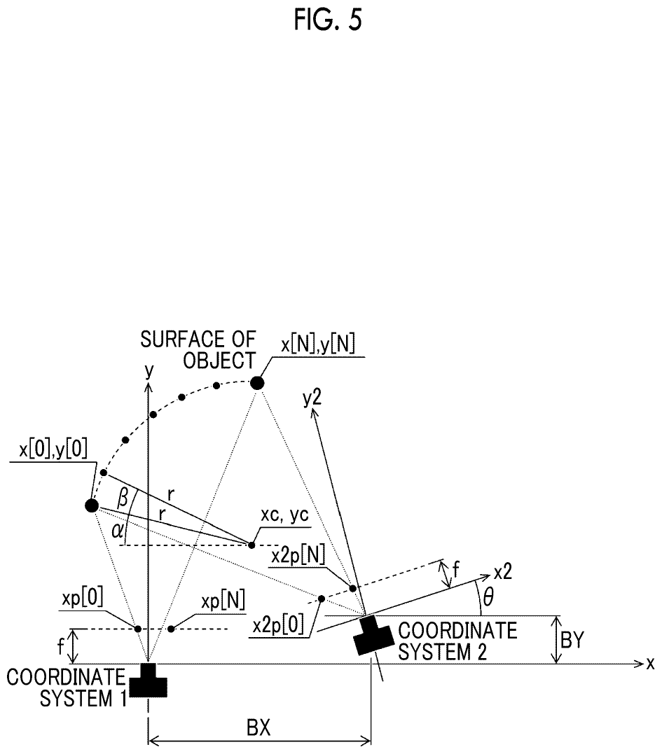

Next, a positional relationship between the respective points on a surface of an object on the imaging surfaces 1 and 2 (captured images 1 and 2) will be considered likewise in a case where the surface of the object is curved. FIG. 5 schematically shows the imaging system 1, the imaging system 2, and the surface of the object to be imaged in an xy coordinate space. Since only the surface of the object is different from that in FIG. 1, only the surface of the object will be described. In FIG. 5, the surface of the object is a circular arc having a center (xc, yc) (coordinates in the coordinate system 1) and a radius r. A point P[0] positioned at a position corresponding to an angle α on the circular arc and points P[1], . . . , P[N] arranged from the point P[0] at regular intervals of an angle β are considered. Coordinates (x, y) of the respective points in the coordinate system 1 are represented by the following Equations (4a) and (4b). Here, i is 0, 1, . . . , N. Further, α denotes an angle from an x axis on a negative side and is defined to be positive in a clockwise direction. Furthermore, β is also defined to be positive in the clockwise direction. In a case where x[i] and y[i] of Equations (4a) and (4b) are put into Equation (1), coordinates xp[0], . . . , xp[N] on the imaging surface 1 can be obtained. Further, in a case where x[i] and y[i] of Equations (4a) and (4b) are put into Equations (2a) to (2d) and Equation (2e), coordinates x2p[0], . . . , x2p[N] on the imaging surface 2 can be obtained.

x[i]=xc−r*cos(α+i*β) (4a)

y[i]=yc+r*sin(α+i*β) (4b)

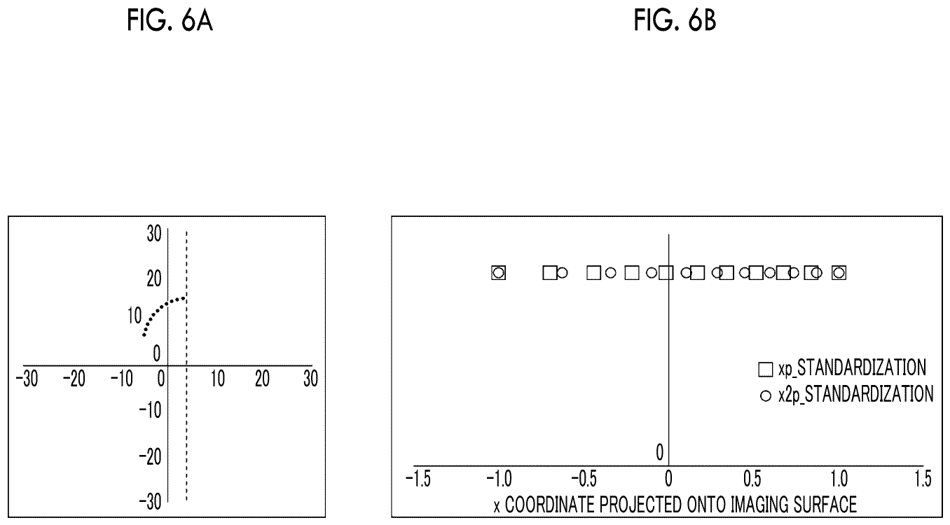

Here, xc is set to 5 m, yc is set to 5 m, r is set to 10 m, α is set to 10°, β is set to 7°, N is set to 10, BX is set to 4 m, BY is set to 0 m, and 0 is set to 0, and coordinates xp[0], . . . , xp[10] of the points P[0], . . . , P[10] on the imaging surface 1 and coordinates x2p[0], . . . , x2p[10] of the points P[0], . . . , P[10] on the imaging surface 2 are obtained and compared with each other, and results thereof are shown in FIGS. 6A and 6B. Viewpoints in FIGS. 6A and 6B are the same as those in FIGS. 2A to 4B. It can be seen from FIGS. 6A and 6B that the standardized coordinates xp[1], . . . , xp[9] and the standardized coordinates x2p[1], . . . , x2p[9] do not coincide with each other, that is, the positions of non-reference points do not coincide with each other, even though the points P[0] and P[10] are used as reference points and the captured images 1 and 2 are subjected to geometric correction so that the positions of the reference points coincide with each other.

[Case where Positions of Non-Reference Points do not Coincide with Each Other (Part 2)]

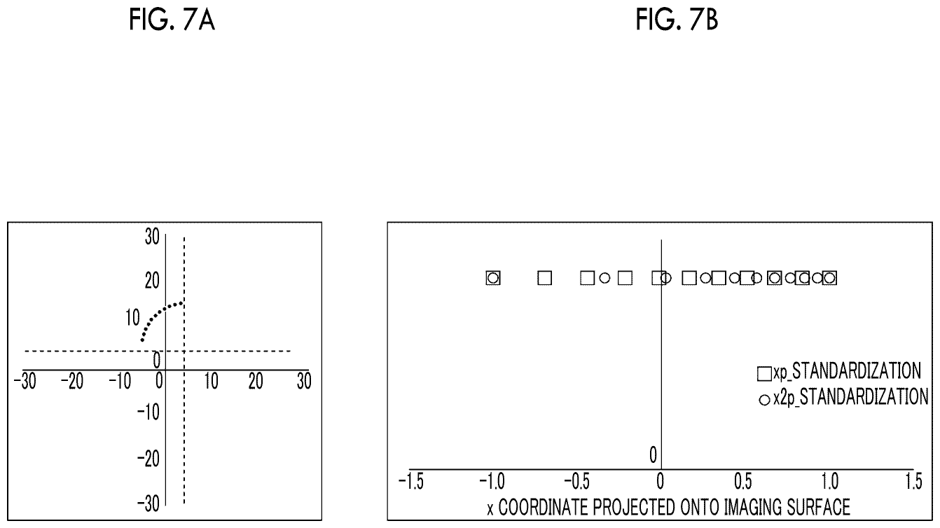

Next, results in a case where the coordinate system 1 and the arrangement of the points P[0], . . . , P[10] are set to be the same as those in FIGS. 6A and 6B and only the coordinate system 2 is changed, specifically, BX is set to 4 m, BY is set to 4 m, and θ is set to 0°, are shown in FIGS. 7A and 7B. Viewpoints in FIGS. 7A and 7B are same as those in FIGS. 6A and 6B. It can be seen from FIGS. 7A and 7B that the standardized coordinates xp[1], . . . , xp[9] and the standardized coordinates x2p[1], . . . , x2p[9] do not coincide with each other. That is, it can be seen that the positions of non-reference points do not coincide with each other even though the points P[0] and P[10] are used as reference points and the captured images 1 and 2 are subjected to geometric correction so that the positions of the reference points coincide with each other.

[Case where Positions of Non-Reference Points do not Coincide with Each Other (Part 3)]

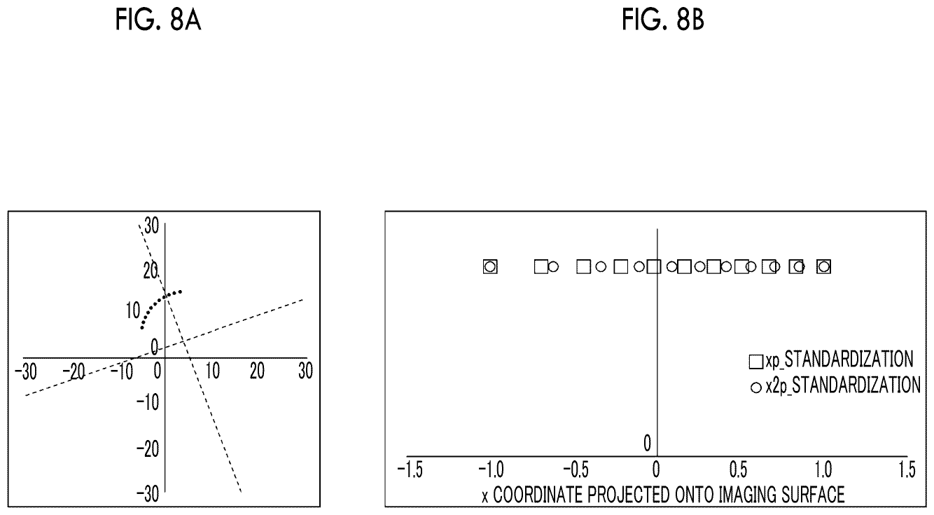

Next, results in a case where the coordinate system 1 and the arrangement of the points P[0], . . . , P[10] are set to be the same as those in FIGS. 6A and 6B and only the coordinate system 2 is changed, specifically, BX is set to 4 m, BY is set to 4 m, and θ is set to 20°, are shown in FIGS. 8A and 8B. Viewpoints in FIGS. 8A and 8B are the same as those in FIGS. 6A and 6B. It can be seen from FIGS. 8A and 8B that the standardized coordinates xp[1], . . . , xp[9] and the standardized coordinates x2p[1], . . . , x2p[9] do not coincide with each other, that is, the positions of non-reference points do not coincide with each other, even though the points P[0] and P[10] are used as reference points and the captured images 1 and 2 are subjected to geometric correction so that the positions of the reference points coincide with each other.

Likewise, even in a case where the coordinate system 1 and the arrangement of the points P[0], . . . , P[10] are set to be the same as those in FIGS. 6A and 6B and only the coordinate system 2 is changed, specifically, BX is set to 4 m, BY is set to 0 m, and θ is set to 20°, a case where the coordinate system 1 and the arrangement of the points P[0], . . . , P[10] are set to be the same as those in FIGS. 6A and 6B and BX is set to 0 m, BY is set to 4 m, and θ is set to 0°, and a case where the coordinate system 1 and the arrangement of the points P[0], . . . , P[10] are set to be the same as those in FIGS. 6A and 6B and BX is set to 0 m, BY is set to 4 m, and θ is set to 20°, results in which the coordinates xp[1], . . . , xp[9] and the coordinates x2p[1], . . . , x2p[9] do not coincide with each other, that is, the positions of non-reference points do not coincide with each other, are obtained (drawings will be omitted).

As described above, it can be seen that, in a case where the surface of the object is curved, the positions of non-reference points do not coincide with each other even though the captured images 1 and 2 are subjected to geometric correction so that the positions of the reference points on the surface of the object coincide with each other.

As described above, it can be seen that, regardless of whether the surface of the object is straight or curved, the positions of non-reference points do not coincide with each other even though the captured images 1 and 2 are subjected to geometric correction so that the positions of the reference points on the surface of the object coincide with each other.

The space of the object to be imaged is assumed to be two-dimensional in FIGS. 1 and 5 for the purpose of description. However, the actual space of the object to be imaged is three-dimensional. Even though the space of the object to be imaged is assumed to be three-dimensional, the surface of the object is assumed as a flat surface or a curved surface, reference points and non-reference points on the surface are considered, and the coordinates of the reference points and the non-reference points on the imaging surfaces of the imaging systems 1 and 2 are obtained and standardized in the same manner so that the coordinates of the reference points coincide with each other, it can be seen that the standardized coordinates of the non-reference points in the imaging systems 1 and 2 do not coincide with each other, that is, the positions of the non-reference points do not coincide with each other, even though the captured images 1 and 2 are subjected to geometric correction so that the coordinates of the reference points coincide with each other.

The inventor of the present invention has made a diligent study in consideration of the above circumstances, and has come up with an idea of solving the above-mentioned problems using the following method.
(1) The visible image and the infrared image in which the same object is imaged from different positions (an example of “two-dimensional images captured in different wavelength ranges”) are acquired.
(2) Information on the positions of points (reference points) serving as a reference on a surface of the object is acquired.
(3) Values of the visible image and the infrared image corresponding to non-reference points other than the reference points on the surface of the object are estimated on the basis of the positions of the reference points on the surface of the object.

Details will be described below.

[Overall Configuration of Image Processing System]

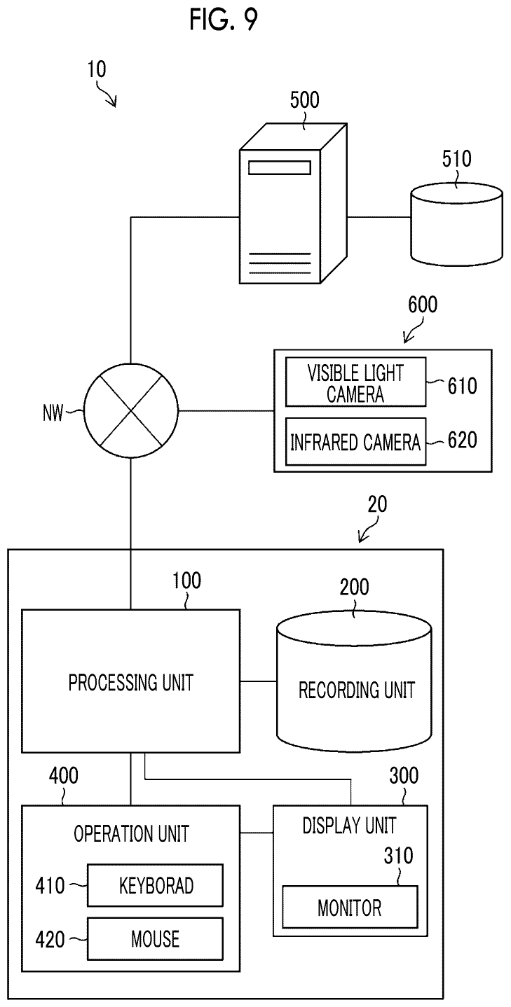

FIG. 9 is a diagram showing an overall configuration of an image processing system according to an embodiment. As shown in FIG. 9, in an image processing system 10, an image processing device 20 (image processing device), a server 500, a database 510, and a camera 600 (imaging device) are connected via a network NW. The image processing system 10 can be formed using a device (information terminal), such as a personal computer, a tablet terminal, or a smartphone.

[Configuration of Image Processing Device]

The image processing device 20 comprises a processing unit 100 (processor), a recording unit 200, a display unit 300, and an operation unit 400, and these units are connected to each other, so that necessary information is transmitted and received. These units may be housed in one housing, or may be housed in independent housings. Further, the respective components may be disposed in remote places and connected to each other via a network.

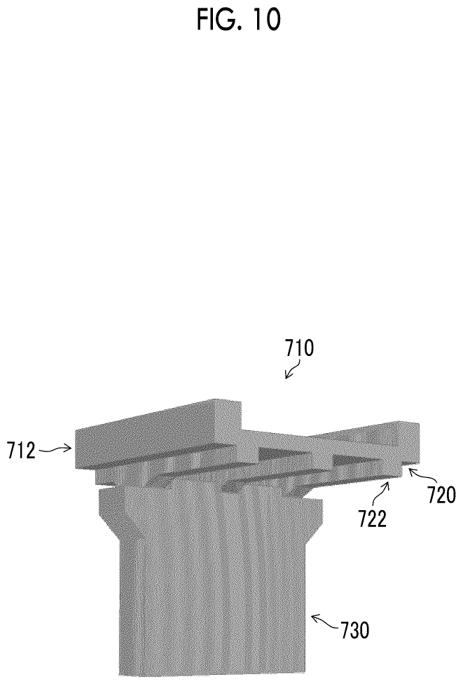

For example, the image processing device 20 acquires an image of a bridge 710 (an example of a concrete structure) shown in FIG. 10, and performs processing, such as the detection of damage or deformation and the registration of images. The bridge 710 includes wall balustrades 712, a floor plate 720 (of which only a part is shown), beams 722, and a pier 730. In the embodiment of the present invention, “registration between the first image and the second image” means that a value of the first image and a value of the second image corresponding to the same point on the surface of the object are associated with each other.

[Configuration of Processing Unit]

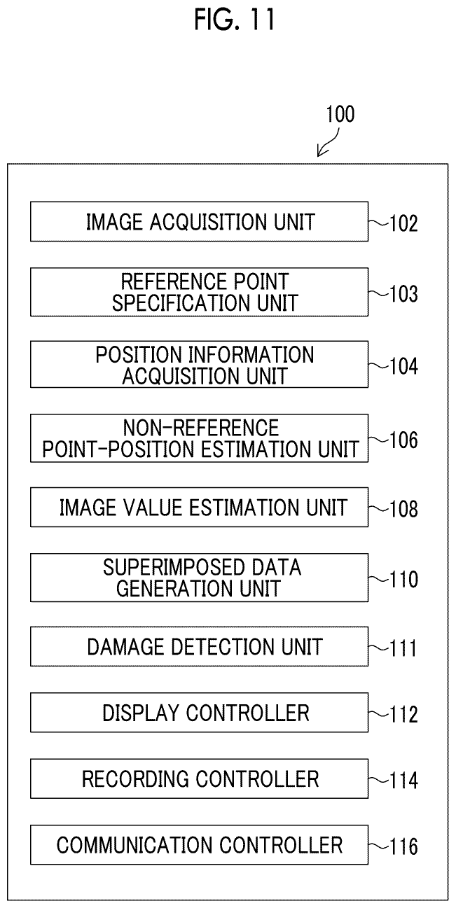

FIG. 11 is a diagram showing a functional configuration of the processing unit 100. The processing unit 100 comprises an image acquisition unit 102, a reference point specification unit 103, a position information acquisition unit 104, a non-reference point-position estimation unit 106, an image value estimation unit 108, a superimposed data generation unit 110, a damage detection unit 111, a display controller 112, a recording controller 114, and a communication controller 116; and performs processing, such as the acquisition of the visible image and the infrared image, the acquisition of information indicating the positions of the reference points, the estimation of the positions of the non-reference points, the estimation of image values, the association of the visible image and the infrared image, and the generation and display of superimposed data. The details of processing performed by each of these units will be described later.

The function of the above-mentioned processing unit 100 can be realized using various processors and recording mediums. The various processors also include, for example, a central processing unit (CPU) that is a general-purpose processor realizing various functions by executing software (programs), a graphics processing unit (GPU) that is a processor specialized in image processing, and a programmable logic device (PLD) that is a processor of which circuit configuration can be changed after manufacture, such as a field-programmable gate array (FPGA). Each function may be realized by one processor or may be realized by a plurality of processors of the same type or different types (for example, a plurality of FPGAs, a combination of a CPU and an FPGA, or a combination of a CPU and a GPU). Further, a plurality of functions may be realized by one processor. The hardware structures of these various processors are more specifically circuitry where circuit elements, such as semiconductor elements, are combined.

In a case where the processor or circuitry described above executes software (programs), a code of the software to be executed that can be read by a computer (for example, various processors or circuitry forming the processing unit 100, and/or a combination thereof) is recorded in a non-transitory recording medium (memory), such as a ROM or a flash memory, and the computer refers to the software. The software recorded in the non-transitory recording medium includes an image processing program that is used to execute the image processing method according to the embodiment of the present invention and data that are used in a case where the image processing program is executed (data of information indicating the positions of the reference points, data used to estimate the positions of the non-reference points, data on the shape of the surface of the object, and the like). The code may be recorded in the non-transitory recording medium (including the recording unit 200), such as various magneto-optical recording devices and a semiconductor memory, instead of the ROM. At the time of execution, information recorded in a recording device, such as the recording unit 200, is used as necessary. Further, for example, a random-access memory (RAM; memory) is used as a transitory storage region at the time of execution.

Some or all of the functions of the processing unit 100 may be realized by a server (processor) on a network, and the image processing device 20 may perform the input of data, communication control, the display of results, and the like. In this case, an application service provider type system is constructed including the server on the network.

[Configuration of Recording Unit]

The recording unit 200 (a recording device, a memory, a non-transitory recording medium) is formed of a non-transitory recording medium, such as a compact disc (CD), a digital versatile disc (DVD), a hard disk, or various semiconductor memories, and a controller therefor; and the visible image, the infrared image, superimposed data and a superimposed image of the visible image and the infrared image, information indicating the positions of reference points and non-reference points, the shape data of the surface (three-dimensional surface) of an object, damage information, and the like are recorded in the recording unit 200. The image processing program that is used to execute the image processing method according to the embodiment of the present invention and data that are used in a case where the image processing program is executed may be recorded in the recording unit 200.

[Configuration of Operation Unit]

The operation unit 400 includes a keyboard 410 and a mouse 420, and a user can perform operations required for image processing according to the embodiment of the present invention using these devices. In a case where a touch panel type device is used, a monitor 310 may be used as an operation unit.

[Display Device]

The display unit 300 comprises a monitor 310 (display device). The monitor 310 is, for example, a device such as a liquid-crystal display, and can display acquired images and processing results.

[Server and Database]

Information, such as the visible image and the infrared image, is recorded in the database 510, and the server 500 controls communication with the image processing device 20. The image processing device 20 can acquire the information that is recorded in the database 510.

[Configuration of Camera]

The camera 600 (an imaging device, an imaging system) comprises a visible light camera 610 that images an object (subject) with light having a wavelength range including at least a part of a wavelength range of visible light, and an infrared camera 620 that images an object with light having a wavelength range including at least a part of a wavelength range of infrared light. The same object is imaged from different positions by the camera 600, so that the visible image and the infrared image (a plurality of two-dimensional images captured in different wavelength ranges) can be obtained. The camera 600 may be mounted on a platform that is pannable and/or tiltable. Further, the camera 600 may be mounted on a movable vehicle, a robot, or a flying object (a drone, or the like).

It is assumed that a relationship between coordinate systems of the visible light camera 610 and the infrared camera 620 (values of parameters indicating a relationship between the positions of origins and the directions of the coordinate systems) is already known and is stored in a memory of the recording unit 200 or the like. For example, parameters, which are calculated from the visible image and the infrared image obtained by imaging performed in a state where the positions and directions of the visible light camera 610 and the infrared camera 620 are fixed at predetermined positions and directions, may be stored in the memory. For example, since many infrared cameras also include visible light cameras built therein, visible images can be captured by the visible light cameras at the same time in a case where infrared images are captured by the infrared cameras. Alternatively, the imaging positions and the imaging directions of the visible light camera 610 and the infrared camera 620 may be specified by the separate measuring means. GPS or Wi-Fi positioning can be applied to specify the imaging position, and a publicly known method, such as a gyro sensor or an acceleration sensor, can be applied to specify the imaging direction. The processing unit 100 (processor) can use stored information as necessary.

[Procedure of Image Processing]

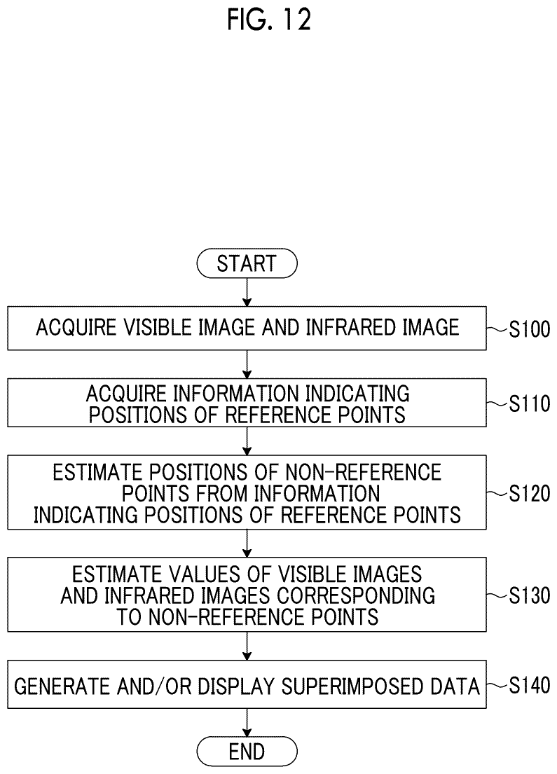

FIG. 12 is a flowchart showing a procedure of the image processing (each step of the image processing method) according to the embodiment.

### 1. Acquisition of Visible Image and Infrared Image

The image acquisition unit 102 (processor) acquires the visible image and the infrared image in which the same object is imaged from different positions, respectively (Step S100: image acquisition processing, image acquisition step). The image acquisition unit 102 can acquire images from the camera 600, the database 510, and the recording unit 200. Further, the image acquisition unit 102 can acquire the visible image and the infrared image in which, for example, a concrete structure as an object is imaged. Here, it is assumed that a relationship between the coordinate systems of the visible image and the infrared image (a relationship between the imaging positions and the imaging directions) is known as described above.

Hereinafter, for the convenience of description, the visible image may be described as the first image, and the infrared image may be described as the second image. However, as long as there are a plurality of two-dimensional images captured in different wavelength ranges, any image may be treated as the first or second image.

A case where one image is acquired for each of the visible image and the infrared image will be described below, but a plurality of images may be acquired for each of the visible image and the infrared image as described later in the section of “Modification example”.

[Detection of Damage]

The damage detection unit 111 (processor) detects damage (deformation, defects) from the visible image and the infrared image. Items to be detected include, for example, the position, quantity, size, shape, type, degree, and the like of damage. Further, the type of damage includes, for example, fissuring, peeling, water leakage, floating, a cavity, corrosion, the exposure of reinforcing bars, and the like. The damage detection unit 111 can detect damage using a publicly known method (for example, a method based on a local feature quantity of an image). Further, the damage detection unit 111 may detect damage using a trained model (for example, various neural networks) that is formed using machine learning, such as deep learning.

### 2. Acquisition of Information Indicating Positions of Reference Points

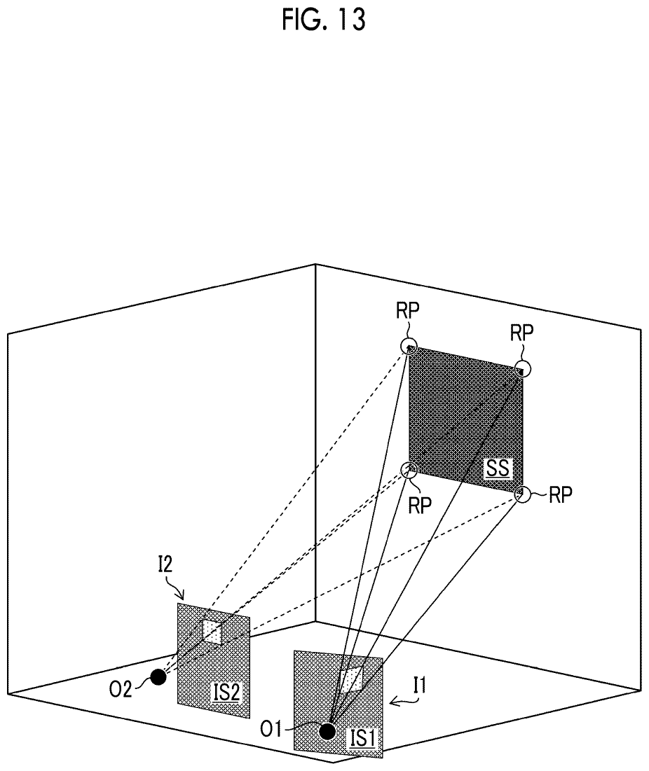

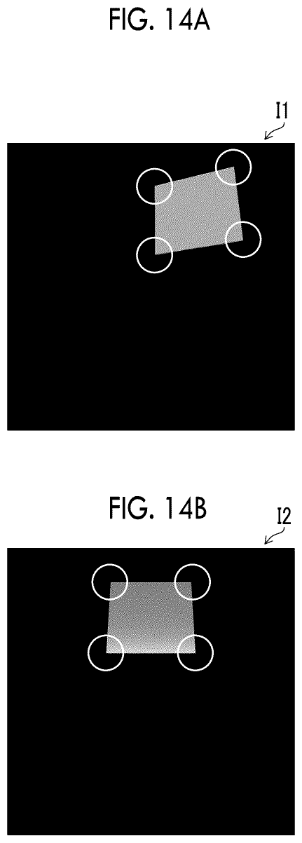

The reference point specification unit 103 and the position information acquisition unit 104 (processor) acquire information indicating the positions of the reference points from the acquired images (Step S110: reference point-position information acquisition processing, reference point-position information acquisition step). This processing includes the specification of the reference points in the visible image and the infrared image (specification processing, a specification step) and the acquisition of information indicating the positions of the reference points on the surface of the object (acquisition processing, an acquisition step). FIG. 13 is a schematic diagram showing an aspect in which the positions of reference points RP on a surface SS of an object are obtained, and FIGS. 14A and 14B are enlarged views of a visible image I1 and an infrared image I2 shown in FIG. 13. In FIG. 13 and FIGS. 14A and 14B, only one surface of the object is shown for the simplification of description. Further, in FIGS. 14A and 14B, portions other than the surface of the object are displayed in black. Furthermore, in FIGS. 14A and 14B, the reference points specified in the visible image I1 and the infrared image I2 are indicated by white circles. A detailed description will be made below.

[2.1 Specification of Reference Points]

First, the reference point specification unit 103 specifies the reference points in the visible image and the infrared image. For example, the reference point specification unit 103 can specify the positions of markers (for example, metal foil, such as aluminum foil), which can be specified in both the visible image and the infrared image, in the visible image and the infrared image that are captured in a state where the markers are preset on the surface of the object.

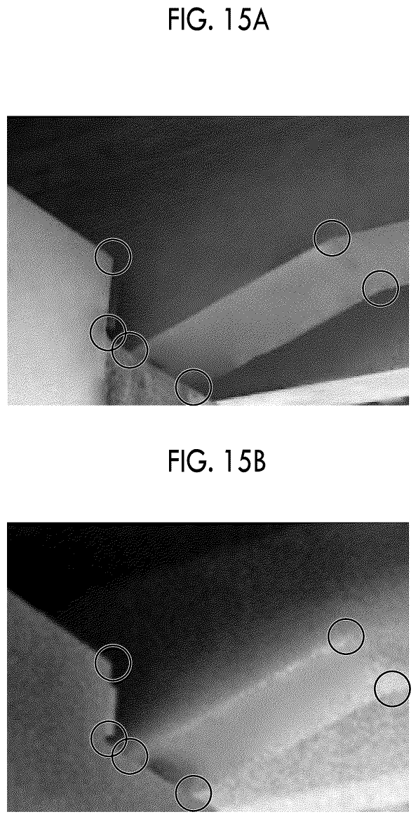

Alternatively, the reference point specification unit 103 may specify and extract the reference points on the basis of the spatial distribution of signal values of the visible image and the infrared image. A publicly known image correlation method of obtaining corresponding points of two images with a stereo camera or the like may be used as the method thereof. That is, regions having a predetermined size are extracted from the visible image and the infrared image, respectively, while coordinates are changed, the correlation between the regions is evaluated, and the coordinates of a region having the highest correlation (similarity) may be obtained as corresponding points. In this case, the reference point specification unit 103 specifies and extracts only corresponding points at which correlation (similarity) between the visible image and the infrared image is equal to or larger than a predetermined value as reference points. The visible image and the infrared image are images of different types, but include portions that can be specified as reference points on the basis of correlation (similarity). For example, ends and bent portions (curved portions) of the surface of the object can be specified as reference points. For example, as described above, in FIGS. 14A and 14B, portions indicated by white circles in the visible image I1 and the infrared image I2 can be specified as reference points. FIGS. 15A and 15B are diagrams showing examples in which reference points are specified in the visible image (FIG. 15A) and the infrared image (FIG. 15B) in which a concrete structure (for example, the bridge 710 shown in FIG. 10) is imaged. In the examples shown in FIGS. 15A and 15B, the reference point specification unit 103 can specify, for example, portions surrounded by circles as reference points on the basis of correlation (similarity). Since a relationship between high and low signal values may be reversed in the visible image and the infrared image, it is preferable that the reference point specification unit 103 evaluates the absolute value of a correlation value as correlation (similarity). In a case where the reference point specification unit 103 specifies reference points in the visible image and the infrared image, values of the visible image and values of the infrared image corresponding to the reference points can be obtained. That is, the values of the visible image and the values of the infrared image corresponding to the reference points can be obtained in Step S110. The values of the visible image corresponding to the reference points are, for example, red, green, and blue (RGB) values corresponding to the reference points. Further, the values of the infrared image corresponding to the reference points are, for example, infrared (IR) values corresponding to the reference points.

[2.2 Acquisition of Information Indicating Positions of Reference Points]

Next, the position information acquisition unit 104 obtains the positions of the respective reference points on the surface of the object (the positions of the respective reference points in a three-dimensional space of the object to be imaged) on the basis of the positions of the respective reference points in the visible image and the infrared image. Directions of the reference points in the coordinate systems of the imaging systems for the images can be specified on the basis of the positions of the reference points in the images. As already described, an image in which the respective points on the surface of the object are projected onto the imaging surface in a direction of the optical center is a captured image. Accordingly, the positions of the reference points in the image are positions at which the reference points on the surface of the object are projected onto the imaging surface in the direction of the optical center. Therefore, the reference points on the surface of the object are positioned in directions of straight lines connecting the optical center to the reference points on the imaging surface. Relationships between positions and directions in (the coordinate system of) the imaging system for a visible image and (the coordinate system of) the imaging system for an infrared image are already known. Accordingly, the position information acquisition unit 104 can obtain intersections (intersections in the three-dimensional space of the object to be imaged; for example, in the case of the schematic diagram of FIG. 13, intersections between solid lines and dotted lines, points indicated by four circles) between directions that can be specified from the positions of the reference points in the visible image (for example, in the case of the schematic diagram of FIG. 13, directions of straight lines (solid lines) connecting an optical center O1 of the imaging system for a visible image I1 to reference points on an imaging surface IS1 thereof) and directions that can be specified from the positions of the reference points in the infrared image (for example, in the case of the schematic diagram of FIG. 13, directions of straight lines (dotted lines) connecting an optical center O2 of the imaging system for an infrared image I2 to reference points on an imaging surface IS2 thereof), as the positions of the reference points on the surface of the object (for example, in the case of the schematic diagram of FIG. 13, the positions of the reference points RP on the surface SS of the object). The above description can be easily understood from the schematic diagrams shown in FIGS. 1, 5, 13, 14A, and 14B.

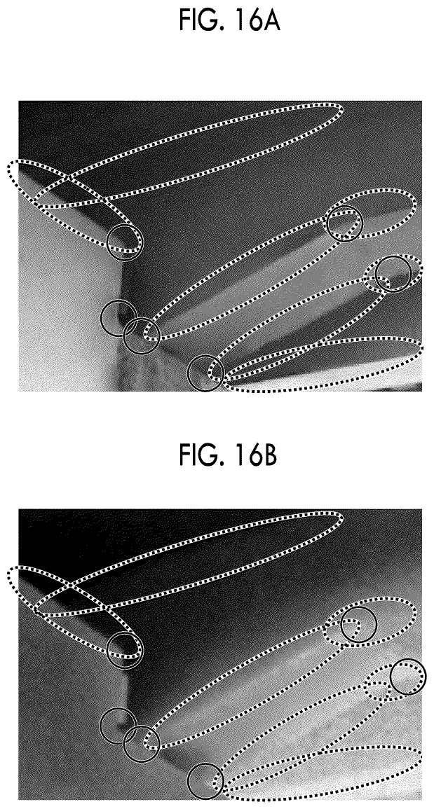

In a case where reference points are specified and extracted on the basis of correlation (similarity) between the visible image and the infrared image, boundaries of the surface of the object can also be extracted as reference points. For example, in the case of the visible image and the infrared image shown in FIGS. 15A and 15B, not only ends and bent portions (curved portions) of the surface of the object but also boundary portions other than the ends and bent portions are extracted as reference points. In addition to the portions surrounded by circles in FIGS. 15A and 15B, other portions extracted as portions having high correlation (similarity) at the boundaries of the surface of the object are shown in FIGS. 16A and 16B by dotted circles (oval symbols). Boundaries are straight lines in FIGS. 16A and 16B. In a case where regions having a predetermined size at boundaries in the visible image (or the infrared image) are extracted by an image correlation method and correlation (similarity) between the extracted regions and regions having a predetermined size at boundaries in the infrared image (or the visible image) is evaluated, correlation (similarity) is increased in a plurality of regions along the boundaries. In a case where the boundaries of the surface of the object are curves, correlation (similarity) is increased in the respective portions along the curves. In any case, not only ends of the surface of the object but also other boundaries (straight lines or curves) can be extracted as portions having high correlation (similarity).

As described above, it is preferable that at least one reference point is a point present at any one of an end, a bent portion (curved portion), or a boundary of the object. The position information acquisition unit 104 (processor) may perform highlighting processing of highlighting one or more of an end, a curved portion, or a boundary of the object on at least one of the visible image or the infrared image (at least one of the first image or the second image), and may perform reference point-position information acquisition processing (reference point-position information acquisition step) using the image subjected to the highlighting processing.

In the embodiment of the present invention, a portion in the visible image and a portion in the infrared image, which can be specified as the same portion on the surface of the object, are referred to as “reference points”. One portion of the above-mentioned end of the surface of the object can be specified as the same portion in the visible image and the infrared image. Further, each portion on the above-mentioned boundary of the surface of the object can also be specified as the same portion in the visible image and the infrared image. Accordingly, in the embodiment of the present invention, a portion that can be specified as “the same portion on the surface of the object” regardless of whether the portion is the end of the surface of the object or the boundary thereof is referred to as “reference point”. Likewise, both one portion (point) on the surface of the object and a plurality of portions (line) continuous on a line are referred to as “reference points”. However, since a method of obtaining the positions of the reference points on the surface of the object on the basis of the positions of the reference points in the visible image and the infrared image is slightly different depending on whether the reference point is one portion (point) or a plurality of portions (line) positioned on a line, it is necessary to distinguish between the respective cases (a case where the reference point is one portion and a case where the reference point is a plurality of portions positioned on a line).

In a case where the reference point is one portion (point), as described above, the position information acquisition unit 104 can obtain intersections between straight lines that connect the origin (optical center) of the coordinate system of the imaging system for a visible image to reference points on an imaging surface thereof and straight lines that connect the origin (optical center) of the coordinate system of the imaging system for an infrared image to reference points on an imaging surface thereof, as the positions of the reference points on the surface of the object.

In a case where the reference point is a plurality of portions (line) positioned on a line, the position information acquisition unit 104 can obtain an intersection between a straight line that connects the origin (optical center) of the coordinate system of the imaging system for a visible image (or the infrared image) to one reference point positioned on a line on an imaging surface and a plane that includes the origin (optical center) of the coordinate system of the imaging system for an infrared image (or the visible image) and a line positioned on an imaging surface (a plane formed of straight lines connecting the origin of the coordinate system to the respective reference points positioned on the line on the imaging surface), as the position of the one reference point on the surface of the object. In a case where the reference point is a plurality of portions (line) positioned on a line, the positions of the respective reference points, which are positioned on the line, on the surface of the object can be obtained by this method.

In a case where the reference point is a plurality of portions positioned on a straight line, the position information acquisition unit 104 needs to obtain the positions of the respective reference points, which are positioned on the straight line, on the surface of the object via the latter method described above, that is, via a method of obtaining an intersection between a straight line corresponding to one point positioned on a straight line in one image and a plane corresponding to the straight line in the other image. On the other hand, in a case where the reference point is a plurality of portions positioned on a curve, the position information acquisition unit 104 can also obtain the positions of the respective reference points, which are positioned on the curve, on the surface of the object via the former method, that is, via a method of obtaining an intersection between a straight line corresponding to one point positioned on the curve in one image and a straight line corresponding to one point, which is specified as the same point as the one point on the curve in the other image, as long as the position information acquisition unit 104 can specify the respective portions, which are positioned on the curve, in the visible image and the infrared image. Meanwhile, as an alternative method of the latter, a line of intersection between a plane that includes the origin (optical center) of the coordinate system of the imaging system for one image and a line positioned on an imaging surface and a plane that includes the origin (optical center) of the coordinate system of the imaging system for the other image and a line positioned on an imaging surface can also be obtained as the position of the reference point, which has the form of a line in each image, on the surface of the object.

### 3. Estimation of Positions of Non-Reference Points

The non-reference point-position estimation unit 106 (processor) estimates the positions of non-reference points, which are points other than the reference points on the surface (three-dimensional surface) of the object, on the basis of the positions of the reference points on the surface (three-dimensional surface) of the object (from the information indicating the positions of the reference points) (Step S120: non-reference point-position estimation processing, non-reference point-position estimation step). This processing includes processing of estimating the shape of the surface (three-dimensional surface) of the object on the basis of the positions of the reference points on the surface (three-dimensional surface) of the object (shape estimation processing, a shape estimation step), and processing of estimating the positions of the non-reference points on the basis of the estimated shape of the surface (three-dimensional surface) of the object (position estimation processing, a position estimation step). A detailed description will be made below.

[3.1 Estimation of Shape of Surface (Three-Dimensional Surface) of Object]

In order to estimate the positions of the non-reference points on the surface of the object, it is necessary to estimate the shape of the surface (three-dimensional surface) of the object on the basis of the information indicating the positions of the reference points. The shape of a local triangular region surrounded by three reference points can be approximated by a flat surface uniquely determined depending on the positions of these three reference points. Accordingly, the non-reference point-position estimation unit 106 forms an initial triangular flat surface according to (1) to be described below, and then repeats the formation of another triangular flat surface to be connected to the already formed triangular flat surface according to (2), so that the shape of the surface of the object can be approximated by a shape in which the triangular flat surfaces are connected (a set of flat surfaces, each of which being defined by three reference points).
(1) First, three reference points, which are closest to each other, (three reference points in which the longest distance of distances between two arbitrary reference points of the three reference points is shortest) are extracted from a plurality of reference points on the surface of the object to form a triangular flat surface.
(2) Reference points, which are next closest to each of the two reference points of the apexes of the already formed triangle, (reference points of which the longer distance of the distances from the respective two reference points is shortest) are extracted to form a triangular flat surface.

Here, other reference points cannot be present inside the respective triangular flat surfaces as viewed from the imaging system for a visible image and the imaging system for an infrared image. That is, other reference points cannot be present inside a triangular pyramid that consists of the optical center of the imaging system for a visible image and each of the triangles, and inside a triangular pyramid that consists of the optical center of the imaging system for an infrared image and each of the triangles. Accordingly, the non-reference point-position estimation unit 106 forms the respective triangular flat surfaces such that other reference points are not present inside all of the triangular flat surfaces, each of which being formed by three reference points, excluding such triangular flat surfaces.

Meanwhile, in a case where not only a reference point having the form of one portion (point), such as an end of the surface of the object, but also a reference point of a plurality of portions (line) continuously present on a line, such as a boundary of the surface of the object, are included in the reference points that are specified in Step S110 (the acquisition of information indicating the positions of the reference points) and extracted, it is preferable that the non-reference point-position estimation unit 106 changes a rule for forming a triangular flat surface depending on whether the reference point is a point or a line. Specifically, in the case of a reference point having the form of a point, it is preferable that the non-reference point-position estimation unit 106 forms a triangular flat surface such that the reference point is an apex. In the case of a reference point having the form of a line, it is preferable that the non-reference point-position estimation unit 106 forms a triangular flat surface such that the reference point (line) is one side. Here, in a case where the line is a curve, a surface which includes the curve as one side does not have a triangular shape and is not necessarily a flat surface. However, the non-reference point-position estimation unit 106 may form flat surfaces including such a surface and connect the flat surfaces to estimate the shape of the surface of the object.

The surface of the object is not necessarily connected in the entire range of the visible image and the infrared image, and may also include a portion where the surface is discontinuous due to shading or the like. For example, in the visible image and the infrared image shown in FIGS. 15A and 15B (and FIGS. 16A and 16B), a discontinuous portion is also included in the surface of the object. A triangular flat surface formed on the basis of the reference point in such a discontinuous portion is incorrect as an approximation of the shape of the surface of the object. Accordingly, in order to accurately estimate the shape of the surface in such a case as well, it is preferable that the non-reference point-position estimation unit 106 discriminates respective connected regions of the surface of the object in the visible image and the infrared image, forms triangular flat surfaces in the connected regions on the basis of the reference points on the boundaries and inside of the respective connected regions, and connects the triangular flat surfaces to estimate the shape of the surface of the object. The non-reference point-position estimation unit 106 can discriminate the connected regions on the basis of signal values of the visible image and the infrared image and spatial features, such as edges or textures.

Here, since the visible image is usually formed of RGB images (images in red, green, and blue wavelength ranges) in which reflection intensity distributions in three different types of wavelength ranges in a wavelength range of visible light are imaged, respectively, the non-reference point-position estimation unit 106 can discriminate the connected regions on the basis of the signal values of the RGB images and spatial features, such as edges or textures of the respective images. In a case where the object is a concrete structure, for example, as shown in FIGS. 15A and 15B (and FIGS. 16A and 16B), the non-reference point-position estimation unit 106 extracts pixel groups, which can be regarded as a concrete surface, from the respective pixels of the visible image first. For example, in a case where the RGB signal values of each pixel are included in predetermined ranges that can be regarded as RGB values of a concrete surface, the non-reference point-position estimation unit 106 extracts each pixel as the pixel groups that can be regarded as a concrete surface. After extracting the pixel groups, the non-reference point-position estimation unit 106 distinguishes the pixel groups in more detail on the basis of the RGB signal values of each pixel and spatial features. Then, the non-reference point-position estimation unit 106 fills and expands the respective pixel groups via morphology expansion calculation. Finally, the non-reference point-position estimation unit 106 can contract the respective expanded pixel groups to optimum regions using an active contour method, and determine the regions to which the respective pixel groups correspond as the connected regions. The non-reference point-position estimation unit 106 can apply snakes, a level-set method, or the like as the active contour method.

Meanwhile, even though the surface of the object is discontinuous in the visible image, it may be difficult to determine a discontinuous boundary since the RGB signal values of the respective regions sandwiching the discontinuous boundary of the surface are close to each other. On the other hand, since the temperatures of the respective regions sandwiching the discontinuous boundary are different from each other in the infrared image, the boundary may also be clear. For this reason, it is preferable that the non-reference point-position estimation unit 106 determines the connected regions on the basis of the visible image and the infrared image. There are many methods, such as a mean shift method and a graph cuts method, as a method of determining the connected regions (distinguishing and determining the respective regions sandwiching a discontinuous boundary). The non-reference point-position estimation unit 106 may apply any one of the methods to determine the connected regions. The non-reference point-position estimation unit 106 may determine a method of determining the connected regions according to a user's operation.

The non-reference point-position estimation unit 106 may apply a method of machine learning to determine the connected regions. For example, the non-reference point-position estimation unit 106 may use a method such as a convolutional neural network (CNN), a fully convolution network (FCN), convolutional networks for biomedical image segmentation (U-Net), or a deep convolutional encoder-decoder architecture for image segmentation (SegNet) to determine the connected regions.

A method of determining the connected regions is not particularly limited as long as the method is a method based on the features of the visible image and the infrared image, and the non-reference point-position estimation unit 106 may apply any of the methods. The type of the visible image (the types of signal values) used for determination is not limited to three types (RGB), and may be one type, two types, or four or more types.

Meanwhile, the respective connected regions of the surface of the object are defined by regions in directions of (the coordinate systems of) the imaging systems for a visible image and an infrared image. Specifically, each connected region of the surface of the object is defined by a region in a direction of a straight line that connects the origin (optical center) of the coordinate system of the imaging system corresponding to each of the visible image and the infrared image to each pixel of the connected region on an imaging surface (that is, a region in a direction surrounded by a straight line connecting the origin of the coordinate system of the corresponding imaging system to each pixel of a boundary of the connected region on an imaging surface). Here, overlapping regions (inner regions) among the regions in the directions obtained from the visible image and the infrared image, respectively, are regarded as the connected regions of the surface of the object (the reason for this is that, in a case where a discontinuous boundary is recognized in any one of the visible image or the infrared image, the connected region is limited by the boundary).

[3.1(1) Estimation of Shape of Surface (Three-Dimensional Surface) of Object by Fitting of Free-Form Surface]

Since the visible image and the infrared image are images of different types, the number of reference points, which can be specified as the same portion on the surface of the object in [2. Acquisition of information indicating positions of reference points], is small. That is, since the visible image and the infrared image are images of different types, portions where the spatial distributions of the signal values of the images are similar are few even at the same portions on the surface of the object in a case where reference points are to be specified on the basis of correlation (similarity) between the images. Here, the fact that the visible image and the infrared image are images of different types means that the visible image and the infrared image are images captured by cameras having sensitivity in different wavelength ranges. Further, even if markers that can be specified in both the visible image and the infrared image are preset on the surface of the object, the number of the markers is small. Accordingly, in a case where the respective connected regions of the surface of the object are to be discriminated in the visible image and the infrared image as described above, the shape of the surface of the object in the regions may be estimated on the basis of the positions of all the reference points on the boundaries and inside of the connected regions instead of forming and connecting triangular flat surfaces. Specifically, a free-form surface, such as a Bezier surface or a B-spline surface, may be fitted to the reference points on the boundaries and inside of the connected regions to estimate the shape of the surface (in this case, the fitted curved surface does not necessarily need to pass through all the reference points). Here, before the free-form surface is fitted, each connected region of the surface of the object may be further divided into respective regions that are smoothly connected (in a case where there is a portion where an inclination is rapidly changed on the surface of the object, the region may be divided with the portion where an inclination is rapidly changed as a boundary). By the already described method of discriminating the connected regions on the basis of the signal values of the visible image and the infrared image and spatial features, such as edges or textures, the respective connected regions of the surface of the object can be discriminated and the respective regions, which are more finely and smoothly connected, can also be discriminated (respective regions separated at portions where an inclination is rapidly changed can also be discriminated).

[3.1(2) Estimation of Shape of Surface (Three-Dimensional Surface) of Object Using Fitting of Surface Having Specific Shape]

There is a case where the shape of a surface is known in advance depending on an object (it is known that a surface has a predetermined shape). For example, in a case where an object is a concrete structure, the shape of the surface of the object is often known in advance. For example, the surface is often a flat surface as in the example shown in FIGS. 15A and 15B (and FIGS. 16A and 16B). Further, in the case of a tunnel, a surface is often a cylindrical surface. In a case where the shape of the surface of the object is known in advance as described above, it is preferable that the non-reference point-position estimation unit 106 predetermines a function representing the shape of the surface, such as a flat surface, a cylindrical surface, or a spherical surface, instead of a free-form surface, and optimizes and fits parameters of the function to best match the positions of reference points on the boundaries and inside of each (smoothly) connected region of the surface of the object in each region to estimate the shape of the surface. For example, in a case where it is known in advance that the surface of the object is a flat surface, the non-reference point-position estimation unit 106 may fit a flat surface to best match the positions of reference points on the boundaries and inside of each (smoothly) connected region of the surface of the object in each region to estimate the shape of the surface. Since it is known in advance that the surface SS of the object is a flat surface in the case of, for example, the schematic diagram of FIG. 13, the non-reference point-position estimation unit 106 fits a flat surface to best match the positions of four reference points RP on the boundaries of a (smoothly) connected region of the surface SS of the object in the region to estimate the shape of the surface SS of the object. Further, for example, in a case where it is known in advance that the surface of the object is a cylindrical surface, the non-reference point-position estimation unit 106 may fit a cylindrical surface to estimate the shape of the surface of the object.

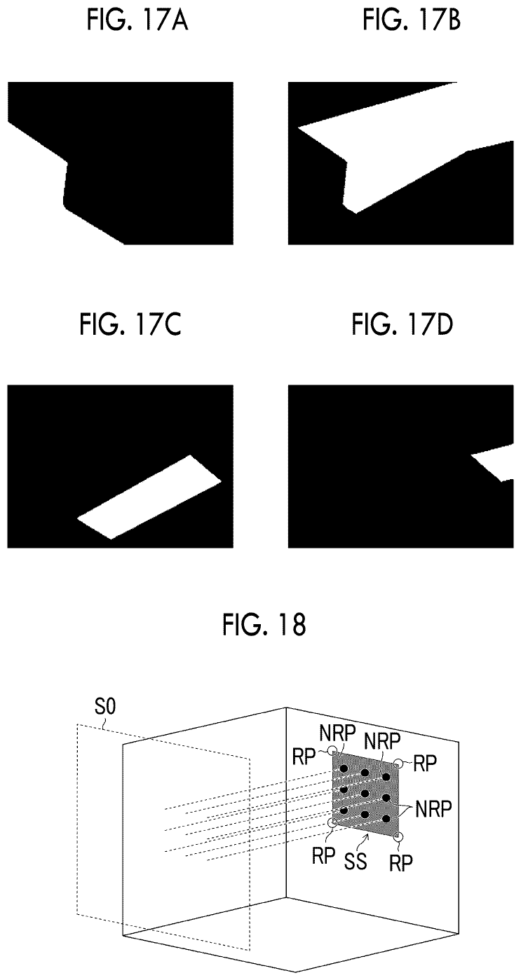

With regard to the example shown in FIGS. 15A and 15B (and FIGS. 16A and 16B), FIGS. 17A, 17B, 17C, and 17D show examples of results of discriminating the respective smoothly connected regions of the surface of the object (concrete structure) on the basis of the signal values of the visible image and spatial features, such as edges or textures. In FIGS. 17A, 17B, 17C, and 17D, the surface of a region shown in FIG. 17A is discontinuous with (not connected to) the surfaces of the other regions, and the surfaces of the respective regions shown in FIGS. 17B, 17C, and 17D are continuous (connected) but are not smoothly connected (separated at portions where an inclination is rapidly changed). Since it is known in advance that the surface of this object (concrete structure) is a flat surface, the non-reference point-position estimation unit 106 can fit a flat surface to best match the positions of the reference points having the form of a point and the reference points having the form of a line, which are shown in FIGS. 15A and 15B and 16A and 16B, on the surface of the object in the respective regions of the surface of the object shown in FIGS. 17A, 17B, 17C, and 17D, to estimate the shape of the surface.

In a case where the shape (predetermined shape) of the surface of an object corresponds to a flat surface, the non-reference point-position estimation unit 106 can estimate the shape of the surface as long as at least three reference points (reference points not positioned on the same straight line) are positioned on the surface of the object. Further, in a case where the shape of the surface of an object corresponds to a spherical surface, the non-reference point-position estimation unit 106 can estimate the shape of the surface as long as at least four reference points (reference points not positioned on the same flat surface) are positioned on the surface of the object. Furthermore, in a case where the shape of the surface of an object corresponds to a cylindrical surface, the non-reference point-position estimation unit 106 can estimate the shape of the surface as long as at least five reference points are positioned on the surface of the object.

In a case where the shape of the surface of an object is represented by a predetermined function, the minimum number of reference points required for optimizing and fitting the parameters of the function to estimate the shape of the surface is determined according to the number of parameters (independent parameters) of the function. Of course, as the number of reference points becomes larger, the accuracy of the estimation of the shape of a surface (the accuracy of fitting) is further improved.

Meanwhile, in a case where there are restrictions on a relationship between the imaging system (coordinate system) for a visible image and the imaging system (coordinate system) for an infrared image and the position or direction of the surface of the object, the non-reference point-position estimation unit 106 can estimate the shape of the surface of the object on the basis of fewer reference points. For example, in a case where the surface of an object is a flat surface, for example, in a case where one angle of two angles between the coordinate system for any one of the visible image or the infrared image and the surface (flat surface) of the object is determined (one angle (any one of θ or ϕ) in a case where a direction of a normal vector to the surface (flat surface) of the object is represented by two angles θ and ϕ of polar coordinates in the coordinate system for any one of the visible image or the infrared image is determined), the non-reference point-position estimation unit 106 can estimate the shape of the surface as long as at least two reference points are positioned on the surface of the object.

Further, for example, in a case where an angle between the coordinate system for any one of the visible image or the infrared image and the surface (flat surface) of the object is determined (including a case where a direction of a normal vector to the surface (flat surface) of the object is determined in the coordinate system for any one of the visible image or the infrared image and a case where the surface of the object is parallel to any plane of the coordinate system), the non-reference point-position estimation unit 106 can estimate the shape of the surface as long as at least one reference point is positioned on the surface of the object.

Further, for example, in a case where the surface of an object is a cylindrical surface, for example, in a case where one angle of two angles between the coordinate system for any one of the visible image or the infrared image and a direction of an axis of the cylindrical surface of the object is determined (one angle (any one of θ or ϕ) in a case where the direction of the axis of the cylindrical surface of the object is represented by two angles θ and ϕ of polar coordinates in the coordinate system for any one of the visible image or the infrared image is determined), the non-reference point-position estimation unit 106 can estimate the shape of the surface as long as at least four reference points are positioned on the surface of the object.

Furthermore, for example, in a case where an angle between the coordinate system for any one of the visible image or the infrared image and the direction of the axis of the cylindrical surface of the object is determined (including a case where the direction of the axis of the cylindrical surface of the object is determined in the coordinate system for any one of the visible image or the infrared image and a case where the axis of the cylindrical surface is parallel to any axis of the coordinate system), the non-reference point-position estimation unit 106 can estimate the shape of the surface as long as at least three reference points are positioned on the surface of the object.

Furthermore, for example, in a case where any axis of the coordinate system for any one of the visible image or the infrared image and the axis of the cylindrical surface of the object coincide with each other, the non-reference point-position estimation unit 106 can estimate the shape of the surface as long as at least one reference point is positioned on the surface of the object.

The shape (“predetermined shape” described above) of the surface of the object may be ascertained from a design drawing or computer-aided design (CAD) data. Further, a three-dimensional model created from an image in which the object is imaged may be used.

[3.2 Estimation of Positions of Non-Reference Points]

The non-reference point-position estimation unit 106 can arrange non-reference points using various methods with respect to the shape of the surface (three-dimensional surface) of the object that is estimated by the above-mentioned method. For example, the non-reference point-position estimation unit 106 may arrange non-reference points to correspond to the respective pixels of the visible image (or the infrared image). Here, “arrange non-reference points to correspond to the respective pixels of the visible image (or the infrared image)” means that a non-reference point is disposed in a direction of a straight line connecting the origin (optical center) of the coordinate system of the imaging system for a visible image (or the infrared image) to the coordinates of each pixel on the imaging surface corresponding to the visible image (or the infrared image), that is, non-reference points are arranged on the basis of a perspective projection model (central projection model). Further, “arrange” means that a straight line corresponding to each non-reference point is defined (that is, the position of the non-reference point on the surface of the object has not been estimated yet).

In addition, the non-reference point-position estimation unit 106 may dispose a non-reference point in a direction of a straight line parallel to the optical axis (a z axis of the coordinate system) from the coordinates of each pixel on the imaging surface after making the imaging surface wider, that is, may arrange non-reference points on the basis of a parallel projection model (orthographic projection model). An image based on a parallel projection model is referred to as an orthoimage (orthophoto). That is, the non-reference point-position estimation unit 106 may dispose a non-reference point to correspond to each pixel of the orthoimage. In the case of the parallel projection model, the shape of the object can be more accurately represented without distortion (non-reference points can be arranged at more regular intervals with respect to the object).

Further, the non-reference point-position estimation unit 106 may arrange non-reference points on the basis of a perspective projection model or a parallel projection model and on the basis of (a coordinate system of) an imaging system different from (the coordinate system of) the imaging system for a visible image and (the coordinate system of) the imaging system for an infrared image. That is, the non-reference point-position estimation unit 106 may arrange non-reference points on the basis of a perspective projection model or a parallel projection model in an imaging system (coordinate system) having an arbitrary position and direction.

FIG. 18 is a schematic diagram showing an aspect of the arrangement of non-reference points based on a parallel projection model (orthographic projection model) in the schematic diagram of FIG. 13. In FIG. 18, an imaging surface of a non-reference point is denoted by S0, and a non-reference point is disposed in a direction of a straight line (a straight line shown by a dotted line) parallel to the optical axis (the z axis of a coordinate system of a non-reference point) from the coordinates of each pixel on the imaging surface S0. Meanwhile, straight lines corresponding to the respective non-reference points are sparsely shown in FIG. 18 to allow description to be easily understood. Further, the surface SS of the object, which is estimated on the basis of information indicating the positions of the reference points RP, is also shown in FIG. 18.

Hereinafter, an imaging system (coordinate system) on which a non-reference point is based will be referred to as an imaging system (coordinate system) for a non-reference point.

After estimating the shape of the surface of the object as described above, the non-reference point-position estimation unit 106 obtains the position of an intersection between a straight line that extends in a direction corresponding to each of the non-reference points arranged on the basis of the imaging system (coordinate system) for a non-reference point and the estimated surface of the object, as the position of a non-reference point on the surface of the object. In a case where the surface of the object is approximated by a shape in which triangular flat surfaces are connected, the non-reference point-position estimation unit 106 may determine a triangle through which straight lines extending in directions corresponding to the respective non-reference points pass, and may obtain the positions of intersections between the triangular flat surface and the straight lines. At this time, in a case where a connected region of the surface of the object is discriminated as already described, the shape of the surface is estimated only in the connected region of the surface of the object (a triangular flat surface is formed). Accordingly, the straight lines extending in the directions corresponding to the non-reference points may not intersect with the estimated surface of the object (triangular flat surface). In this case, the non-reference point-position estimation unit 106 may not obtain the positions of the non-reference points corresponding to the directions and may obtain the positions of the non-reference points only in the connected region of the surface of the object. Even in a case where the non-reference point-position estimation unit 106 discriminates the respective connected regions of the surface of the object or the respective regions, which are more smoothly connected, and fits a free-form surface or a surface having a predetermined shape on the basis of the positions of all the reference points on the boundaries and inside of the respective regions to estimate the shape of the surface in the respective regions, the non-reference point-position estimation unit 106 may obtain the positions of intersections between the straight lines extending in directions corresponding to the respective non-reference points and the estimated surface of the object in the same manner. In the schematic diagram of FIG. 18, the positions of intersections between straight lines (straight lines shown by dotted lines) that correspond to the respective non-reference points arranged on the basis of a parallel projection model (orthographic projection model) and the surface SS of the object that is estimated on the basis of the positions of the reference points RP are obtained as positions of the non-reference points NRP on the surface SS of the object.

Meanwhile, in order to obtain the positions of the non-reference points on the surface of the object using the above-mentioned method, the non-reference point-position estimation unit 106 needs to transform the positions of the reference points on the surface of the object and the respective surfaces, which are estimated as the shape of the surface of the object, into the coordinate system of a non-reference point. In the subsequent description as well, transformation of the coordinate system for a visible image and the coordinate system for a non-reference point and transformation of the coordinate system for an infrared image and the coordinate system for a non-reference point are required in some places. However, the description of such coordinate transformation will be omitted as appropriate in the following description (the reason for this is that it is obvious that those coordinate systems can be transformed since relationships between positions and directions in the coordinate system for a visible image and the coordinate system for a non-reference point, and relationships between positions and directions in the coordinate system for an infrared image and the coordinate system for a non-reference point are already known.)

### 4. Association of Visible Image and Infrared Image

The image value estimation unit 108 (processor) estimates values of the visible image (first image) and values of the infrared image (second image) corresponding to the non-reference points on the three-dimensional surface of the object on the basis of the acquired first image, the acquired second image, and the acquired information indicating the positions of the reference points, and associates the values of the visible image with the values of the infrared image (Step S130: association processing, association step). Since there are two methods of estimating the values of images, the methods will be described in order. The values of the visible image (first image) and the values of the infrared image (second image) corresponding to the reference points are obtained in a case where the reference points are specified in the visible image (first image) and the infrared image (second image) in Step S110 as already described.

[4.1 Method of Estimating Values of Images Corresponding to Non-Reference Point (Part 1)]

The first method is a method of projecting each non-reference point onto the imaging surface of the visible image to estimate a corresponding value of the visible image and projecting each non-reference point onto the imaging surface of the infrared image to estimate a corresponding value of the infrared image. The image value estimation unit 108 can transform coordinates of a non-reference point on the surface of the object in the imaging system (coordinate system) for a non-reference point into coordinates in the imaging system (coordinate system) for a visible image and then project the coordinates onto the imaging surface of the visible image in the direction of the optical center (the origin of the coordinate system) of the imaging system for a visible image; and can estimate the value of the visible image (the value of the first image) at the coordinates from the coordinates of the non-reference point on the imaging surface of the visible image via interpolation calculation of values of pixels of the visible image that surround the coordinates. Likewise, the image value estimation unit 108 can project coordinates of a non-reference point onto the imaging surface of the infrared image to estimate the value of the infrared image (the value of the second image) at the coordinates. The image value estimation unit 108 can estimate corresponding values of the visible image and the infrared image for each non-reference point using the above-mentioned method.

[4.2 Method of Estimating Values of Images Corresponding to Non-Reference Point (Part 2)]

The second method is a method of projecting each pixel of the visible image and each pixel of the infrared image on the surface of the object to estimate values of the visible image and the infrared image corresponding to each non-reference point. As already described, an image in which the respective points on the surface of the object are projected onto the imaging surface in a direction of the optical center is a captured image. Accordingly, the image value estimation unit 108 can obtain the position of an intersection between a straight line that passes through the coordinates of each pixel on the imaging surface of the visible image from the optical center (the origin of the coordinate system) of the imaging system for a visible image and the estimated surface of the object, as the position where each pixel of the visible image is projected onto the surface of the object. The value of the visible image (the value of the first image) at the position of a non-reference point on the surface of the object can be estimated for each non-reference point via interpolation calculation on the basis of the positions and values of the respective pixels of the visible image that surround the position of each non-reference point. Likewise, the image value estimation unit 108 can also estimate the value of the infrared image (the value of the second image) at the position of a non-reference point on the surface of the object. Corresponding values of the visible image and the infrared image can be estimated for each non-reference point by the above-mentioned method.

Meanwhile, in a case where a non-reference point is disposed to correspond to each pixel of the visible image (or the infrared image), the image value estimation unit 108 may naturally employ the value of each pixel of the visible image (or the infrared image) as it is as the value of the visible image (or the infrared image) corresponding to each non-reference point.

[4.3 Example of Estimation Result]

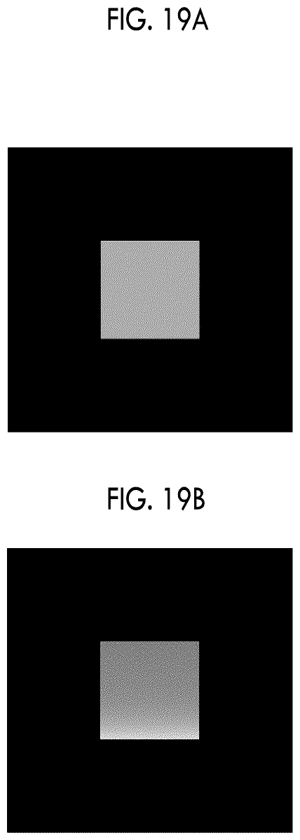

FIGS. 19A and 19B are diagrams showing results of estimating values of the visible image and the infrared image at each pixel on the imaging surface S0 of a non-reference point shown in the schematic diagram of FIG. 18. Specifically, FIGS. 19A and 19B are diagrams showing results of estimating the corresponding values of the visible image and the infrared image for each non-reference point NRP corresponding to each pixel on the imaging surface S0 via the above-mentioned method on the basis of a position on the surface of the object and the visible image I1 and the infrared image I2 shown in FIGS. 14A and 14B (and FIG. 13). FIG. 19A shows an estimation result of the value of the visible image, and FIG. 19B shows an estimation result of the value of the infrared image (gray density in FIGS. 19A and 19B shows the value of the image, and a peripheral black region indicates a region other than the surface of the object). FIGS. 19A and 19B also show the values of the visible image and the infrared image at the pixels corresponding to the reference points RP among the respective pixels on the imaging surface S0 shown in FIG. 18.

### 5. Generation and Display of Superimposed Data/Superimposed Image

The superimposed data generation unit 110 (processor) and the display controller 112 (display controller) generate data in which the value of the visible image (the value of the first image) and the value of the infrared image (the value of the second image) corresponding to each point including the non-reference point are superimposed at the same pixel position, and/or cause the monitor 310 (display device) to display a superimposed image in which the value of the visible image (the value of the first image) and the value of the infrared image (the value of the second image) corresponding to each point including the non-reference point are superimposed at the same pixel position (Step S140: data generation processing/data generation step, display processing/display step). “Each point including the non-reference point” means that each point includes at least the non-reference point, and also means that each point includes the reference point and points other than the non-reference point. There are various known methods as a method of superimposing two types of images, and the superimposed data generation unit 110 may use any of those methods.

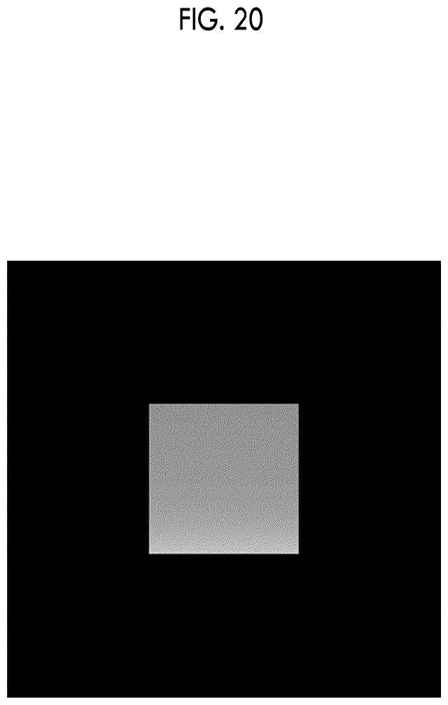

FIG. 20 is a diagram showing an example of a result (superimposed image) in which the value of the visible image and the value of the infrared image are superimposed on the same image position in the examples shown in FIGS. 19A and 19B. In the example shown in FIG. 20, the superimposed data generation unit 110 weight-averages the value of the visible image and the value of the infrared image corresponding to each point including the non-reference point. Specifically, the superimposed data generation unit 110 multiplies the visible image by a weight of 0.4, multiplies the infrared image by a weight of 0.6, and adds the visible image and the infrared image together to generate a superimposed image. That is, a value of the superimposed image=0.4×the value of the visible image+0.6×the value of the infrared image. The display controller 112 can cause the monitor 310 to display this image. The value of the weight is not limited thereto, and can be set as appropriate.

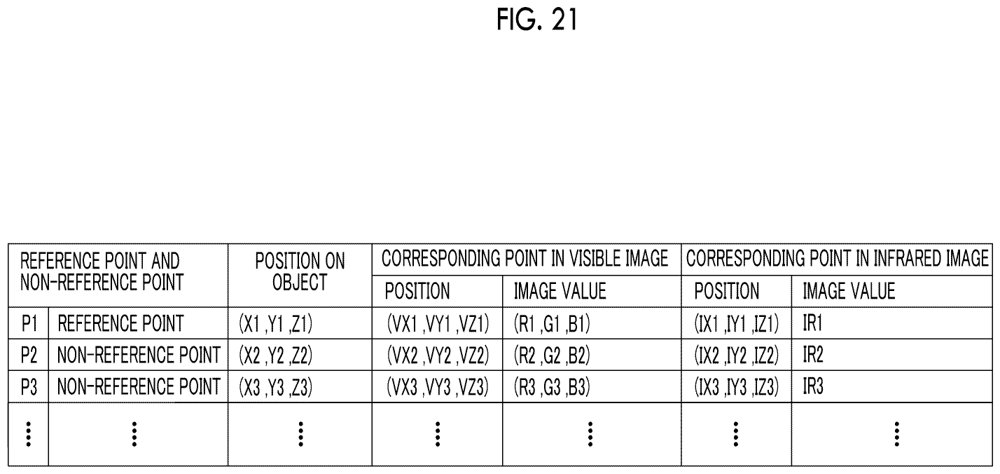

FIG. 21 is a diagram showing an example in which superimposed data are shown in the form of a table. In the example shown in FIG. 21, the superimposed data generation unit 110 associates the positions of a reference point (P1) and non-reference points (P2 and P3) on the object, the values thereof at a corresponding point in the visible image, and the values thereof at a corresponding point in the infrared image. Accordingly, it is possible to ascertain the values of images of points (the reference point or the non-reference point) on the object at a corresponding point in the visible image and the infrared image.

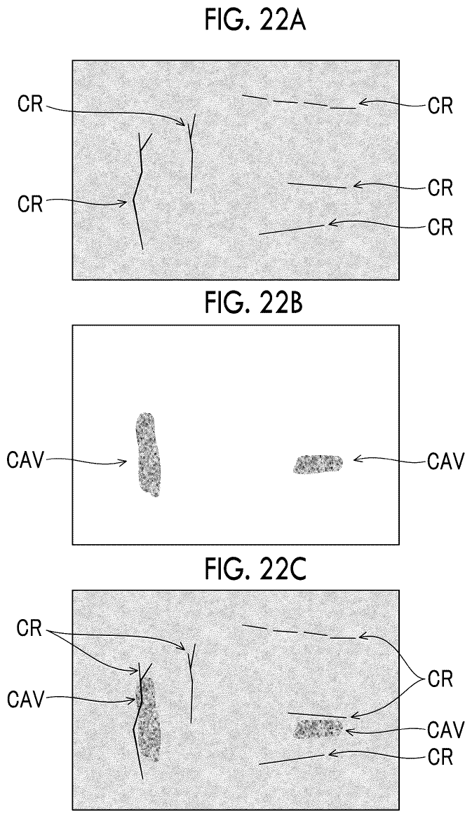

FIGS. 22A, 22B, and 22C are diagrams showing examples of a visible image, an infrared image, and a superimposed image. FIGS. 22A to 22C show the visible image, the infrared image, and the superimposed image of the same portion of the object, respectively. Damage to the surface (fissuring CR) of the object is clearly shown in the visible image, and damage (cavity CAV) in the object is clearly shown in the infrared image. Therefore, according to the embodiment of the present invention, it is possible to observe an aspect of damage on the surface and inside at the same point of the object using a superimposed image accurately registered as described above. Further, as described above, it is possible to discriminate damage that is accompanied by damage to the surface, such as fissuring or peeling, as well and damage that is not accompanied by the damage to the surface, among damages inside the object. Further, although not clearly shown in FIGS. 22A, 22B, and 22C, portions in which damage is caused by repair marks on the surface of the object, the adhesion of a foreign substance, such as free lime, color unevenness (mold, moss, a release agent, a water effect, or the like), masonry joints, steps, slag, sand streaks, rust fluid, rust, surface unevenness, and the like (portions at which actual and/or apparent surface temperature is different from the surroundings due to the state or the like of the surface of the object and false detection occurs in the diagnosis of damage inside the object), and portions in which damage is caused inside the object can be discriminated among portions at which a surface temperature is different from the surroundings in the infrared image as described above. Since the value of the first image and the value of the second image corresponding to the same point (non-reference point) on the surface of the object are correctly associated with each other as in the embodiment of the present invention, it is possible to reduce misregistration in associating a plurality of images. In the embodiment of the present invention, points in the first image and points in the second image do not necessarily need to be associated with each other. According to the embodiment of the present invention, particularly, in a case where a visible image is also used at the same time in the diagnosis of an internal defect, such as floating, based on an infrared image, it is possible to improve the performance of the diagnosis of an internal defect, such as floating, by reducing misregistration between the visible image and the infrared image.

The recording controller 114 (processor) can cause the recording unit 200 to record the superimposed data and/or the superimposed image illustrated in FIGS. 20 to 22C.

### 6. Modification Example

[6.1 Case where a Plurality of Visible Images and Infrared Images are Acquired]

A case where the image acquisition unit 102 (processor) acquires one image for each of the visible image and the infrared image in Step S100 (image acquisition processing, image acquisition step) has been described in the above-mentioned embodiment, but the image acquisition unit 102 may acquire a plurality of images, which are captured at different positions and/or in different directions, for each image. In this case, the position information acquisition unit 104 (processor) can specify and extract the same reference points in the plurality of visible images and infrared images in Step S110 (reference point-position information acquisition processing, reference point-position information acquisition step) (this can be applied not only in a case where markers are set on the surface of an object in advance but also in a case where reference points are specified on the basis of the spatial distribution of signal values of the image.)

For example, in a case where reference points are specified on the basis of the spatial distribution of signal values of the image and an image correlation method is used as a method therefor, the position information acquisition unit 104 can specify and extract reference points in two respective images, of which imaging positions and/or imaging directions are close to each other, among, for example, the plurality of visible images and infrared images using an image correlation method, and then specify and extract the same reference points in the plurality of visible images and infrared images on the basis of a relationship between the positions (coordinates) of the reference points specified and extracted in the respective images. Then, the position information acquisition unit 104 (processor) can obtain the positions of the respective reference points on the surface of the object with higher accuracy (than in a case where one image is used for each of the visible image and the infrared image) on the basis of the positions of the respective reference points in the plurality of visible images and infrared images. In a case where the positions of the respective reference points on the surface of the object are obtained from the positions of the respective reference points in the plurality of visible images and infrared images, the position information acquisition unit 104 (processor) may obtain points (or lines) where respective straight lines (a case where the reference point is a reference point having the form of a point) or respective surfaces (a case where the reference point is a reference point having the form of a line) corresponding to the positions of the respective reference points in the respective images are most concentrated (cross), as the positions of the reference points on the surface of the object.

Meanwhile, in a case where a plurality of images are to be acquired for each of the visible image and the infrared image in Step S100, one image may be selected for each of the visible image and the infrared image in Step S120 and subsequent steps, the image value estimation unit 108 may estimate the values of the visible image and the infrared image corresponding to the respective non-reference points using the already described method, and the superimposed data generation unit 110 and the display controller 112 may generate and/or superimpose and display superimposed data. Alternatively, in a case where the respective connected regions or the respective smoothly connected regions of the surface of the object are to be discriminated in Step S120, the non-reference point-position estimation unit 106 may discriminate the respective regions in a plurality of visible images and infrared images on the basis of signal values and spatial features, such as edges or textures, and may regard overlapping regions (inner regions) among regions in the respective directions discriminated in the respective plurality of visible images and infrared images as the connected regions or smoothly connected regions of the surface of the object. Further, in a case where the values of the visible images and the infrared images corresponding to the respective non-reference points are to be estimated in Step S130, the image value estimation unit 108 may obtain corresponding values from the respective plurality of visible images for each non-reference point, and may obtain an average value of these values as the value of the visible image corresponding to the non-reference point. Likewise, the image value estimation unit 108 may obtain corresponding values from the respective plurality of infrared images, and may obtain an average value of these values as the value of the infrared image corresponding to the non-reference point.

In a case where a plurality of images captured at different positions and/or in different directions are acquired for each of the visible image and the infrared image in Step S100, a relationship between the imaging positions and/or imaging directions of the respective images does not necessarily need to be known. In this case, the image acquisition unit 102 (processor) can obtain the imaging positions and imaging directions of the respective images via the application of a “structure from motion” (SfM; multi-view stereo photogrammetry) technique. In addition, even though a visual simultaneous localization and mapping (SLAM) technique is used, the imaging positions and imaging directions of the respective images can be obtained likewise. Since a technique for estimating the imaging positions and the imaging directions using a plurality of captured images has been studied and proposed at present, any of the techniques may be used.

In [2. Acquisition of information indicating positions of reference points] to [4. Association of visible image and infrared image], various parameters (correction parameters for lens distortion, and the like) related to the respective imaging systems for a visible image and an infrared image are actually required for the conversion of the positions of the reference points, the non-reference points, and the like in the captured images (the positions of the reference points, the non-reference points, and the like on the imaging surfaces) and the positions thereof on the surface of the object. Parameters required for the conversion of these positions are recorded in the memory in advance, and the conversion is performed on the basis of these parameters.

[6.2 Acquisition of Position Information of Reference Points Using Distance Measuring Device]

In Step S110 (reference point-position information acquisition processing, reference point-position information acquisition step), reference points may not be specified in the visible image and the infrared image by the reference point specification unit 103, and the position information acquisition unit 104 may directly set the respective reference points on the surface of the object using a separate distance measuring method (distance measuring unit, distance measuring device) and obtain the positions of the reference points. For example, a device that measures a distance using a stereo image or a laser beam can be used as the distance measuring unit. The distance measuring method (distance measuring unit, distance measuring device) is, for example, light detection and ranging (LiDAR), a stereo camera, a time of flight (TOF) camera, or a sensor, such as an ultrasonic sensor. In this case, the position information acquisition unit 104 can set the respective reference points on the surface of the object and obtain the values of the visible image (first image) and the values of the infrared image (second image) corresponding to the respective reference points. Specifically, a relationship between the positions and directions of (the coordinate system of) a distance measurement system and (the coordinate system of) the imaging system for a visible image and (the coordinate system of) the imaging system for an infrared image is already known. For this reason, in a case where the position information acquisition unit 104 sets the respective reference points on the surface of the object (and obtains the positions of the respective reference points) using the distance measuring method, the positions of the reference points in the visible image (first image) (positions at which the reference points are projected onto the imaging surface of the visible image (first image)) and the positions of the reference points in the infrared image (second image) (positions at which the reference points are projected onto the imaging surface of the infrared image (second image)) can be obtained. Accordingly, the position information acquisition unit 104 can obtain the values of the visible image (first image) and the values of the infrared image (second image) corresponding to the reference points. Alternatively, the position information acquisition unit 104 may not obtain the values of the visible image (first image) and the values of the infrared image (second image) corresponding to the respective reference points, and may obtain the values of the visible image (first image) and the values of the infrared image (second image) corresponding to the reference points at the same time in a case where the image value estimation unit 108 estimates the values of the visible image (first image) and the values of the infrared image (second image) corresponding to the non-reference points in Step S130 (association processing, association step). Meanwhile, in a case where a distance is measured by a stereo camera, the visible image may be an image that is captured by the stereo camera.

[6.3 Application to Other Images]

A problem to be solved by the embodiment of the present invention is not limited to the visible image and the infrared image, and occurs regardless of the type of image. That is, in a case where “two images of different types in which the same object is imaged from different positions are subjected to geometric correction so that the positions of reference points coincide with each other”, a problem in that “the positions of non-reference points other than the reference points do not coincide with each other” occurs regardless of the type of image. The above-mentioned problem also occurs in any image of, for example, a near-infrared image, an ultraviolet image, a fluorescent image, and the like in addition to the visible image and the infrared image. Accordingly, the embodiment of the present invention is effective regardless of the type of image. Meanwhile, here, “two images of different types” indicates the respective images that are captured by cameras having sensitivities in different wavelength ranges. “Having sensitivities in different wavelength ranges” includes not only a case where cameras have sensitivities in the respective wavelength ranges not overlapping with each other at all but also a case where cameras have sensitivities in the respective wavelength ranges partially overlapping with each other and partially different from each other. Further, a case where cameras have sensitivities in the same wavelength range also includes a case where the spectral characteristics (spectral sensitivity characteristics) of the respective sensitivities are different from each other and wavelengths at which the sensitivities reach their maximum (peak sensitivity wavelengths) are different from each other (also includes a case where it is regarded that cameras have sensitivities in substantially “different wavelength ranges”). Furthermore, “image” indicates a two-dimensional image captured by a camera. Moreover, “the positions of the non-reference points do not coincide with each other” means that, as already described, positions in two images corresponding to the same point (non-reference point) on the surface of the object do not coincide with each other and positions in two images corresponding to different points (non-reference points) on the surface of the object mistakenly coincide with each other. That is, “the positions of the non-reference points do not coincide with each other” means that the values of two images corresponding to different points (non-reference points) on the surface of the object are mistakenly regarded as the values of two images corresponding to the same point (non-reference point) and the values are associated with each other. Of course, the above-mentioned problem also occurs in the case of “two images of the same type in which the same object is imaged from different positions are subjected to geometric correction so that the positions of reference points coincide with each other”. However, since the number of reference points, which can be specified as the same portions on the surface of the object, is small in a case where two images are of different types, the above-mentioned problem is significant. For this reason, the embodiment of the present invention is particularly effective.

As described above, an image processing device according to a first aspect of the present invention is an image processing device comprising a processor; and the processor acquires a first image and a second image in which the same object is imaged from different positions and which are two-dimensional images captured in different wavelength ranges, acquires information indicating positions of reference points on a three-dimensional surface of the object that are reference for registration between the first image and the second image, and estimates values of the first image and values of the second image corresponding to non-reference points that are points other than the reference points on the three-dimensional surface and associates the values of the first image with the values of the second image on the basis of the acquired first image, the acquired second image, and the acquired information.

In a case where the values of the first image and the values of the second image corresponding to the same points (non-reference points) on the surface of the object are correctly associated with each other as in the first aspect, it is possible to reduce misregistration in associating a plurality of images. In the first aspect, points in the first image and points in the second image do not necessarily need to be associated with each other.

According to a second aspect, in the image processing device according to the first aspect, the information is information that is acquired on the basis of the first image and the second image.

According to a third aspect, in the image processing device according to the first or second aspect, at least one of the reference points is a point present at any one of an end, a curved portion, or a boundary of the object.

According to a fourth aspect, in the image processing device according to any one of the first to third aspects, the information is information that is acquired on the basis of a distance measured by a distance measuring unit. For example, a device that measures a distance using a stereo image or a laser beam can be used as the distance measuring unit.

According to a fifth aspect, in the image processing device according to any one of the first to fourth aspects, the processor estimates positions of the non-reference points on the basis of the information (information indicating the positions of the reference points).

According to a sixth aspect, in the image processing device according to any one of the first to fifth aspects, the processor estimates a shape of the three-dimensional surface on the basis of the information, and estimates positions of the non-reference points on the basis of the estimated shape.

According to a seventh aspect, in the image processing device according to the sixth aspect, the processor estimates the shape as a set of flat surfaces, each of which being defined by three reference points. The seventh aspect is an aspect taking into consideration that the shape of the surface (three-dimensional surface) of the object can be approximated by a flat surface.

According to an eighth aspect, in the image processing device according to the sixth or seventh aspect, the processor estimates the shape on an assumption that the three-dimensional surface is a surface having a predetermined shape. There is a case where the shape of the three-dimensional surface can be ascertained to some extent in advance depending on an object, and fitting to “a surface having a predetermined shape” is performed in such a case in the eighth aspect. In the eighth aspect, it is possible to estimate the shape of the surface (three-dimensional surface) of the object by estimating parameters of an equation that represents, for example, “a surface having a predetermined shape”.

According to a ninth aspect, in the image processing device according to the eighth aspect, the processor estimates the shape on an assumption that the three-dimensional surface is a flat surface. In the ninth aspect, it is possible to estimate parameters of an equation that represents, for example, a flat surface (an aspect of “a surface having a predetermined shape”).

According to a tenth aspect, in the image processing device according to the eighth aspect, the processor estimates the shape on an assumption that the three-dimensional surface is a cylindrical surface. In the tenth aspect, it is possible to estimate parameters of an equation that represents, for example, a cylindrical surface (an aspect of “a surface having a predetermined shape”).

According to an eleventh aspect, in the image processing device according to any one of the first to tenth aspects, the processor discriminates the surface of the object on the basis of the values of at least one image of the first image or the second image. In the eleventh aspect, it is possible to discriminate whether, for example, the surface of the object is connected or discontinuous.

According to a twelfth aspect, in the image processing device according to any one of the first to eleventh aspects, the processor generates data in which the values of the first image and the values of the second image corresponding to at least the non-reference points are superimposed at the same pixel positions, and/or superimposes the values of the first image and the values of the second image, which correspond to at least the non-reference points, at the same pixel positions and causes a display device to display the superimposed values. According to the twelfth aspect, a user can observe the same point on the surface of the same object in different wavelength ranges using data and/or an image that is subjected to association with high accuracy.

According to a thirteenth aspect, in the image processing device according to any one of the first to twelfth aspects, the processor acquires an image which is captured with light having a wavelength range including at least a part of a wavelength range of visible light as one image of the first image and the second image, and acquires an image which is captured with light having a wavelength range including at least a part of a wavelength range of infrared light as the other image of the first image and the second image. The wavelength range including at least a part of the wavelength range of visible light is also suitable to observe the aspect of the surface of the object, and the wavelength range including at least a part of the wavelength range of infrared light is also suitable to observe the aspect of the inside of the object. Therefore, according to the thirteenth aspect, it is possible to accurately associate an image that is used to observe the surface of the object with an image that is used to observe the inside of the object. Accordingly, in a case where an internal defect of the object, such as floating, is diagnosed on the basis of an image that is captured with light having a wavelength range including at least a part of the wavelength range of infrared light and the aspect of the surface of the object is also observed on the basis of an image that is captured with light having a wavelength range including at least a part of the wavelength range of visible light at the same time, it is possible to accurately associate the two images with each other and to improve the performance of the diagnosis of the internal defect of the object, such as floating.

According to a fourteenth aspect, in the image processing device according to any one of the first to thirteenth aspects, the processor acquires the first image and the second image in which a concrete structure as the object is imaged. The concrete structure is, for example, a bridge, a road, a dam, a building, or the like. According to the fourteenth aspect, it is possible to observe the aspect of the concrete structure using a plurality of images that are accurately associated with each other.

An image processing method according to a fifteenth aspect of the present invention is an image processing method that is executed by an image processing device comprising a processor; and the processor acquires a first image and a second image in which the same object is imaged from different positions and which are two-dimensional images captured in different wavelength ranges, acquires information indicating positions of reference points on a three-dimensional surface of the object that are reference for registration between the first image and the second image, and estimates values of the first image and values of the second image corresponding to non-reference points that are points other than the reference points on the three-dimensional surface and associates the values of the first image with the values of the second image on the basis of the acquired first image, the acquired second image, and the acquired information.

According to the fifteenth aspect, as in the first aspect, it is possible to reduce misregistration in associating a plurality of images. In the image processing method according to the fifteenth aspect, the same processing as that in the second to fourteenth aspects may be further executed.

An image processing program according to a sixteenth aspect of the present invention is an image processing program that causes an image processing device comprising a processor to execute an image processing method; and the processor acquires a first image and a second image in which the same object is imaged from different positions and which are two-dimensional images captured in different wavelength ranges, acquires information indicating positions of reference points on a three-dimensional surface of the object that are reference for registration between the first image and the second image, and estimates values of the first image and values of the second image corresponding to non-reference points that are points other than the reference points on the three-dimensional surface and associates the values of the first image with the values of the second image on the basis of the acquired first image, the acquired second image, and the acquired information.

According to the sixteenth aspect, as in the first and fifteenth aspects, it is possible to reduce misregistration in associating a plurality of images. The image processing program according to the sixteenth aspect may be a program that causes the same processing as that in the second to fourteenth aspects to be further executed. A non-transitory recording medium in which a computer-readable code of the program of the aspects is recorded can also be mentioned as an aspect of the present invention.

The embodiments and other examples of the present invention have been described above, but the present invention is not limited to the above-mentioned aspects and can have various modifications.

### EXPLANATION OF REFERENCES

1: coordinate system
2: coordinate system
10: image processing system
20: image processing device
100: processing unit
102: image acquisition unit
103: reference point specification unit
104: position information acquisition unit
106: non-reference point-position estimation unit
108: image value estimation unit
110: superimposed data generation unit
111: damage detection unit
112: display controller
114: recording controller
116: communication controller
200: recording unit
300: display unit
310: monitor
400: operation unit
410: keyboard
420: mouse
500: server
510: database
600: camera
610: visible light camera
620: infrared camera
710: bridge
712: wall balustrade
720: floor plate
722: beam
730: pier
α: angle
β: angle
θ: angle
CR: fissuring
CAV: cavity
I1: visible image
I2: infrared image
IS1: imaging surface
IS2: imaging surface
RP: reference point
NRP: non-reference point
NW: network
O1: optical center
O2: optical center
S0: imaging surface
SS: surface
d: regular interval
r: radius
x2p: coordinates
xp: coordinates
S100 to S140: each step of image processing method

What is claimed is:

1. An image processing device comprising:
a processor,
wherein the processor acquires a first image and a second image in which the same object is imaged from different positions and which are two-dimensional images captured in different wavelength ranges, acquires information indicating positions of reference points on a surface of the object, and associates values of the first image with values of the second image on the basis of the acquired first image, the acquired second image, and the acquired information, the values of the first image and the values of the second image corresponding to non-reference points that are points other than the reference points on the surface.

2. The image processing device according to claim 1,
wherein the information is information that is acquired on the basis of the first image and the second image.

3. The image processing device according to claim 1,
wherein at least one of the reference points is a point present at any one of an end, a curved portion, or a boundary of the object.

4. The image processing device according to claim 1,
wherein the information is information that is acquired on the basis of a distance measured by a distance measuring unit.

5. The image processing device according to claim 1,
wherein the processor estimates positions of the non-reference points on the basis of the information.

6. The image processing device according to claim 1,
wherein the processor estimates a shape of the surface on the basis of the information, and estimates positions of the non-reference points on the basis of the estimated shape.

7. The image processing device according to claim 6,
wherein the processor estimates the shape as a set of flat surfaces, each of which being defined by three reference points.

8. The image processing device according to claim 6,
wherein the processor estimates the shape on an assumption that the surface is a surface having a predetermined shape.

9. The image processing device according to claim 8,
wherein the processor estimates the shape on an assumption that the surface is a flat surface.

10. The image processing device according to claim 8,
wherein the processor estimates the shape on an assumption that the surface is a cylindrical surface.

11. The image processing device according to claim 1,
wherein the processor discriminates the surface of the object on the basis of the values of at least one image of the first image or the second image.

12. The image processing device according to claim 1,
wherein the processor generates data in which the values of the first image and the values of the second image corresponding to at least the non-reference points are superimposed at the same pixel positions, and/or superimposes the values of the first image and the values of the second image, which correspond to at least the non-reference points, at the same pixel positions and causes a display device to display the superimposed values.

13. The image processing device according to claim 1,
wherein the processor acquires an image which is captured with light having a wavelength range including at least a part of a wavelength range of visible light as one image of the first image and the second image, and acquires an image which is captured with light having a wavelength range including at least a part of a wavelength range of infrared light as the other image of the first image and the second image.

14. The image processing device according to claim 1,
wherein the processor acquires the first image and the second image in which a concrete structure as the object is imaged.

15. An image processing method that is executed by a processor, the image processing method comprising:
acquiring a first image and a second image in which the same object is imaged from different positions and which are two-dimensional images captured in different wavelength ranges;
acquiring information indicating positions of reference points on a surface of the object; and
associating values of the first image with values of the second image on the basis of the acquired first image, the acquired second image, and the acquired information, the values of the first image and the values of the second image corresponding to non-reference points that are points other than the reference points on the surface.

16. A non-transitory, computer-readable tangible recording medium which records thereon a program for causing, when read by a computer, the computer to implement the functions of:
acquiring a first image and a second image in which the same object is imaged from different positions and which are two-dimensional images captured in different wavelength ranges;
acquiring information indicating positions of reference points on a surface of the object; and
associating values of the first image with values of the second image on the basis of the acquired first image, the acquired second image, and the acquired information, the values of the first image and the values of the second image corresponding to non-reference points that are points other than the reference points on the surface.
